(19) United States
(12) Patent Application Publication
(10) Pub. No.: US 2026/0235395 A1
(43) Pub. Date: Aug. 13, 2026

(54) LASER INTERFEROMETER AND SPECTROMETER

(71) Applicant: SEIKO EPSON CORPORATION, TOKYO (JP)

(72) Inventor: Jun KITAGAWA, Matsumoto-shi (JP)

(21) Appl. No.: 19/539,103

(22) Filed: Feb. 13, 2026

(30) Foreign Application Priority Data
Feb. 13, 2025 (JP) 2025-021828

(51) Int. Cl. G01B 9/02091; G01J 3/28; G01N 21/39

(52) U.S. Cl. CPC G01B 9/02091; G01J 3/28; G01N 21/39

(57) ABSTRACT

A laser interferometer including a laser source, an optical modulator, a photodetector, a signal oscillator, and a demodulation circuit, and the demodulation circuit includes a DC offset removing unit configured to extract an alternating-current component of laser light reception signal, a first multiplier configured to multiply the alternating-current component by a reference signal, a first filter configured to output a first low-frequency signal, a second multiplier configured to multiply a first multiplied signal by the reference signal, a second filter configured to output a second low-frequency signal, a Lissajous corrector configured to perform ellipse approximation processing on a Lissajous figure drawn using the first low-frequency signal and the second low-frequency signal, calculate a correction value, and adjust an amplitude, and a phase calculator configured to calculate phase information.

The present application is based on, and claims priority from JP Application Serial Number 2025-021828, filed Feb. 13, 2025, the disclosure of which is hereby incorporated by reference herein in its entirety.

### BACKGROUND

### 1. Technical Field

The present disclosure relates to a laser interferometer and a spectrometer.

### 2. Related Art

JP-A-2020-165700 discloses a laser Doppler measurement apparatus that detects a motion of a moving object. In the laser Doppler measurement apparatus, a measurement target is irradiated with laser light, and a motion of the measurement target is measured based on a Doppler-shifted scattered laser light. Specifically, a shift amount of a frequency of the laser light is obtained by the optical heterodyne interferometry, and a speed and displacement of the moving object are obtained from the shift amount.

The laser Doppler measurement apparatus disclosed in JP-A-2020-165700 includes a frequency shifter type optical modulator. The optical modulator includes a quartz crystal AT oscillator that oscillates in a thickness-shear manner, and a diffraction grating having a plurality of grooves arranged in parallel in a displacement direction of the oscillator. The diffraction grating has grooves in a direction that intersects with a oscillation direction of the quartz crystal AT oscillator. When the diffraction grating is irradiated with the laser light, the laser light is diffracted, and the frequency of the laser light is shifted.

JP-A-2020-165700 is an example of the related art.

However, the thickness-shear oscillation is high in resonance frequency. Therefore, a frequency of a modulation signal superimposed on the laser light by the optical modulator disclosed in JP-A-2020-165700 also increases. Accordingly, in the laser Doppler measurement apparatus disclosed in JP-A-2020-165700, it becomes necessary to make a circuit that performs arithmetic processing on the modulation signal or a circuit that converts an analog signal into a digital signal compatible with high-frequency signals. As a result, the cost of these circuits increases.

Therefore, the implementation of a laser interferometer that can reduce a frequency of a signal arithmetic-processed by a demodulation circuit and reduce the cost of the demodulation circuit has become an issue.

On the other hand, when the frequency of the signal arithmetic-processed by the demodulation circuit is reduced as described above, a restriction may occur in a measurable displacement of the measurement target. For example, when the oscillation of the measurement target is measured, the measurement precision decreases when an amplitude falls below a predetermined value.

Therefore, it is required to implement a laser interferometer that can precisely perform measurement even when the displacement of the measurement target is small while achieving cost reduction as described above.

### SUMMARY

A laser interferometer according to an application example of the present disclosure is a laser interferometer for emitting laser light onto an object, receiving the laser light passing through the object, and acquiring displacement of the object, the laser interferometer including:
a laser source configured to emit the laser light;
an optical modulator including a oscillator and configured to add a modulation signal to the laser light using the oscillator;
a photodetector configured to detect a change in intensity of the laser light including the modulation signal and a sample signal added by the object and configured to output laser light reception signal;
a signal oscillator configured to generate a reference signal of a reference frequency using the oscillator as a oscillation source; and
a demodulation circuit configured to demodulate the sample signal from the laser light reception signal based on the reference signal and configured to acquire the displacement of the object, in which
the demodulation circuit includes
a DC offset removing unit configured to remove a direct-current component from the laser light reception signal and extract an alternating-current component,
a first multiplier configured to multiply the alternating-current component by the reference signal and output a first multiplied signal,
a first filter configured to remove a high-frequency component included in the first multiplied signal and output a first low-frequency signal,
a second multiplier configured to multiply the first multiplied signal by the reference signal and output a second multiplied signal,
a second filter configured to remove a high-frequency component included in the second multiplied signal and output a second low-frequency signal,
a Lissajous corrector configured to perform ellipse approximation processing on a Lissajous figure drawn using the first low-frequency signal and the second low-frequency signal, and adjust, based on a correction value obtained by the ellipse approximation processing, at least one of an amplitude of the first low-frequency signal and an amplitude of the second low-frequency signal, and
a phase calculator configured to demodulate the sample signal based on the first low-frequency signal after correction and the second low-frequency signal after correction which are output from the Lissajous corrector and calculate phase information derived from the object.

A spectrometer according to an application example of the present disclosure is a spectrometer including:
the laser interferometer according to the application example of the present disclosure; and
a spectroscopic analyzer that includes a spectroscopic optical system including a movable mirror and that is configured to generate spectroscopic spectrum information derived from a sample, in which
the laser interferometer measures displacement of the movable mirror, and
the spectroscopic analyzer generates the spectroscopic spectrum information based on a measurement result of the displacement of the movable mirror measured by the laser interferometer.

### BRIEF DESCRIPTION OF THE DRAWINGS

FIG. 1 is a functional block diagram illustrating a laser interferometer according to a first embodiment.

FIG. 2 is a schematic configuration diagram illustrating an interference optical system in FIG. 1.

FIG. 3 is a perspective view illustrating a configuration example of an optical modulator illustrated in FIG. 2.

FIG. 4 is a perspective view illustrating another configuration example of the optical modulator illustrated in FIG. 2.

FIG. 5 is a table illustrating coefficients included in a DC term and a term representing a high-order harmonic wave component in series representation of laser light reception signal.

FIG. 6 is a conceptual diagram illustrating a problem occurring in demodulation processing due to a small displacement of an object.

FIG. 7 is a functional block diagram illustrating a configuration of a Lissajous corrector illustrated in FIG. 1.

FIG. 8 is a schematic diagram illustrating Lissajous correction by the Lissajous corrector illustrated in FIG. 7.

FIG. 9 is a conceptual diagram illustrating influences of a perfect circle having an oblateness of 1 and an ellipse having an oblateness of 0.4 on calculation of phase information.

FIG. 10 is a graph illustrating an example of frequency characteristics of a phase delay amount of an alternating-current component passing through a high-pass filter illustrated in FIG. 1.

FIG. 11 is a graph illustrating a result of simulating an influence of a phase delay amount difference ψ₁ on measurement precision of displacement in the design example illustrated in FIG. 10.

FIG. 12 is a graph illustrating a result of simulating an influence of the phase delay amount difference ψ₁ on the accuracy of displacement in the design example illustrated in FIG. 10.

FIG. 13 is a graph created by calculating frequency characteristics (band characteristics) of a gain and frequency characteristics (phase characteristics) of the phase delay amount when the number of stages is changed to one, two, and three in a high-pass filter implemented with an LCR circuit.

FIG. 14 is a functional block diagram illustrating a laser interferometer according to a second embodiment.

FIG. 15 is a functional block diagram illustrating a configuration of a Lissajous corrector illustrated in FIG. 14.

FIG. 16 is a schematic diagram illustrating Lissajous correction by the Lissajous corrector illustrated in FIG. 15.

FIG. 17 is a functional block diagram illustrating a laser interferometer according to a third embodiment.

FIG. 18 is a functional block diagram illustrating a laser interferometer according to a fourth embodiment.

FIG. 19 is a functional block diagram illustrating a spectrometer according to a fifth embodiment.

### DESCRIPTION OF EMBODIMENTS

A laser interferometer and a spectrometer according to the present disclosure will hereinafter be described in detail based on embodiments illustrated in the accompanying drawings.

### 1. First Embodiment

First, a laser interferometer according to a first embodiment will be described.

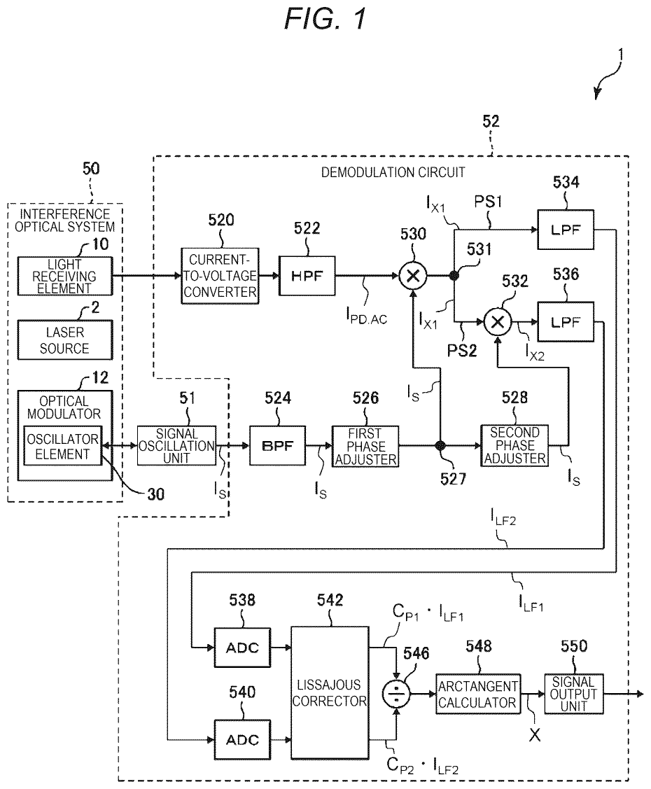

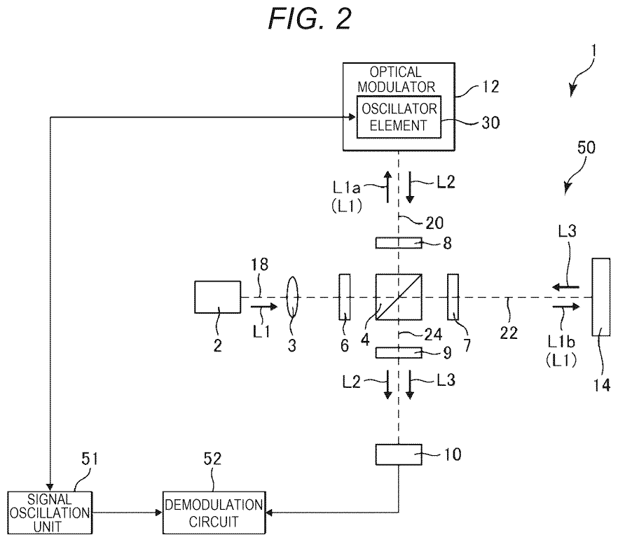

FIG. 1 is a functional block diagram illustrating a laser interferometer 1 according to the first embodiment. FIG. 2 is a schematic configuration diagram illustrating an interference optical system 50 in FIG. 1.

The laser interferometer 1 illustrated in FIG. 1 includes the interference optical system 50, a signal oscillator 51, and a demodulation circuit 52.

The interference optical system 50 illustrated in FIG. 2 splits laser light emitted from a laser source 2 and causes the laser light to be incident on an object 14 and an optical modulator 12, respectively. Then, the laser lights returned from the object 14 and the optical modulator 12, respectively, are received by a photodetector 10 in a mixed manner. The photodetector 10 detects a change in intensity of the laser light including a sample signal (phase information added to the laser light) added by the object 14 and a modulation signal (frequency information added to the laser light) added by the optical modulator 12, and outputs laser light reception signal.

The optical modulator 12 illustrated in FIG. 1 includes the oscillator 30. The optical modulator 12 adds the modulation signal to the laser light using the oscillator 30.

The signal oscillator 51 illustrated in FIG. 1 generates the reference signal using the oscillator 30 as the oscillation source.

The demodulation circuit 52 illustrated in FIG. 1 performs demodulation processing of demodulating the sample signal from the laser light reception signal based on the reference signal. Accordingly, displacement or the like of the object 14 is acquired.

### 1.1. Interference Optical System

The interference optical system 50 illustrated in FIG. 2 is a Michelson type interference optical system. As illustrated in FIG. 2, the interference optical system 50 includes the laser source 2, a collimating lens 3, a light splitter 4, a half-wave plate 6, a quarter-wave plate 7, a quarter-wave plate 8, an analyzer 9, and the photodetector 10.

The laser source 2 emits laser light L1 having a frequency f₀. The photodetector 10 converts an intensity of the received light into an electric signal. The optical modulator 12 changes the frequency of the laser light L1 using the oscillator 30 to generate a reference light L2 (laser light including the modulation signal) including the modulation signal. Meanwhile, the laser light L1 incident on the object 14 is reflected as an object light L3 (laser light t including the sample signal) including the sample signal derived from the object 14.

An optical path connecting the light splitter 4 and the laser source 2 is referred to as an optical path 18. An optical path connecting the light splitter 4 and the optical modulator 12 is referred to as an optical path 20. An optical path connecting the light splitter 4 and the object 14 is referred to as an optical path 22. An optical path connecting the light splitter 4 and the photodetector 10 is referred to as an optical path 24. The term “optical path” in the present specification represents a path which is set between optical elements and on which light travels.

On the optical path 18, the half-wave plate 6 and the collimating lens 3 are disposed in this order from a light splitter 4 side. The quarter-wave plate 8 is disposed on the optical path 20. The quarter-wave plate 7 is disposed on the optical path 22. The analyzer 9 is disposed on the optical path 24.

The laser light L1 emitted from the laser source 2 travels along the optical path 18 and is split by the light splitter 4 into two lights of a first split light L1a and a second split light L1b. The first split light L1a travels along the optical path 20 and is incident on the optical modulator 12. The second split light Lb travels along the optical path 22 and is incident on the object 14. The reference light L2, which has been frequency-shifted and generated by the optical modulator 12, travels along the optical path 20 and the optical path 24 and is incident on the photodetector 10. The object light L3 generated by the reflection on the object 14 travels along the optical path 22 and the optical path 24 and is incident on the photodetector 10.

The laser interferometer 1 including such an interference optical system 50 as described above obtains the phase information about the object 14 using the optical heterodyne interferometry. Specifically, two lights (the reference light L2 and the object light L3) slightly different in frequency from each other are made to interfere with each other. Then, the demodulation circuit 52 extracts the sample signal based on an intensity of an interference light, and obtains the displacement of the object 14 from the sample signal. According to the optical heterodyne interferometry, when extracting the sample signal from the interference light, it is less susceptible to the influence of external disturbances, particularly stray light of frequencies that become noise, and is therefore highly robust.

Hereinafter, each unit of the interference optical system 50 will be further described.

### 1.1.1. Laser Source

The laser source 2 is a laser source that emits the laser light L1 having coherence. As the laser source 2, a source having a linewidth in the MHz band or less is preferably used. Specifically, examples thereof include gas laser such as He—Ne laser, a semiconductor laser element such as a distributed feedback-laser diode (DFB-LD), a fiber Bragg grating laser diode (FBG-LD), a vertical cavity surface emitting laser (VCSEL), and a Fabry-Perot laser diode (FP-LD).

It is particularly preferable for the laser source 2 to be a semiconductor laser element. Accordingly, a size of the laser source 2 can be particularly reduced. Therefore, the reduction in size of the laser interferometer 1 can be achieved.

As the laser source 2, a wavelength-swept laser element may be used, or a wavelength-fixed laser element that continuously emits the laser light L1 having a fixed wavelength may be used. Among them, when the latter wavelength-fixed laser element is used, effects such as simplification of the configuration, reduction in size, and load reduction of the laser source 2 can be obtained.

### 1.1.2. Collimating Lens

The collimating lens 3 is an optical element disposed between the laser source 2 and the light splitter 4, and an example thereof is an aspherical lens. The collimating lens 3 collimates the laser light L1 emitted from the laser source 2 into a collimated light. When the laser light L1 emitted from the laser source 2 is sufficiently collimated, for example, when gas laser such as He—Ne laser is used as the laser source 2, the collimating lens 3 may be omitted.

The laser light L1 that becomes a collimated light passes through the half-wave plate 6 to be converted into a linearly-polarized light having an intensity ratio of a P-polarized light to an S-polarized light of, for example, 50:50, and is then incident on the light splitter 4.

### 1.1.3. Light Splitter

The light splitter 4 is a polarizing beam splitter disposed between the laser source 2 and the optical modulator 12 and between the laser source 2 and the object 14. The light splitter 4 has a function of transmitting the P-polarized light and reflecting the S-polarized light. With this function, the light splitter 4 splits the laser light L1 into the first split light L1a and the second split light L1b.

The first split light L1a, which is an S-polarized light, is converted into a circularly polarized light by the quarter-wave plate 8, and is incident on the optical modulator 12. The first split light L1a incident on the optical modulator 12 is subjected to a frequency shift of IM Hz and is reflected as the reference light L2 including the modulation signal. Accordingly, a frequency of the reference light L2 is f₀+f_{M}. The reference light L2 is converted into a P-polarized light when being transmitted through the quarter-wave plate 8 again. The P-polarized light of the reference light L2 is transmitted through the light splitter 4 and the analyzer 9 and is incident on the photodetector 10.

The second split light L1b, which is a P-polarized light, is converted into a circularly polarized light by the quarter-wave plate 7, and is incident on the object 14 in a moving state. The second split light L1b incident on the object 14 is subjected to a Doppler shift of f_{D} Hz and is reflected as the object light L3 including the sample signal. Accordingly, a frequency of the object light L3 is f₀-f_{D}. The object light L3 is converted into an S-polarized light when being transmitted through the quarter-wave plate 7 again. The object light L3 is reflected by the light splitter 4, is transmitted through the analyzer 9, and is then incident on the photodetector 10. The reference light L2 and the object light L3 are incident on the photodetector 10 as interference lights.

### 1.1.4. Analyzer

Since the S-polarized light and the P-polarized light orthogonal to each other are independent of each other, beating due to interference may not appear when simply superimposing the S-polarized light and the P-polarized light. Therefore, a light wave in which the S-polarized light and the P-polarized light are superimposed is caused to pass through the analyzer 9 tilted by 45° with respect to both the S-polarized light and the P-polarized light. By using the analyzer 9, the reference light L2 and the object light L3 favorably interfere with each other, and an interference light having a beat frequency of |f_{M}−f_{D}| is generated.

### 1.1.5. Photodetector

When the interference light is incident on the photodetector 10, the photodetector 10 outputs a photocurrent (laser light reception signal) corresponding to an intensity of the interference light. A sample signal is demodulated from the laser light reception signal by a method to be described later. An example of the photodetector 10 includes a photodiode. What is received by the photodetector 10 may be laser light in which the modulation signal and the sample signal are superimposed as a result of passing through the optical modulator 12 and the object 14, and is not limited to the interference light generated in the above-described paths. The phrase “demodulating the sample signal from the laser light reception signal” in the present specification refers to extracting the sample signal by performing various calculations on the laser light reception signal. In the following description, not only the photocurrent described above, but also a voltage signal converted from the photocurrent is collectively referred to as a “laser light reception signal”.

### 1.2. Optical Modulator

The optical modulator 12 illustrated in FIG. 1 includes the oscillator 30. The optical modulator 12 modulates a frequency of the first split light L1a using the oscillation of the oscillator 30. According to such a configuration, it is possible to achieve reduction in size, reduction in weight, and low power consumption of the optical modulator 12. The oscillation of the oscillator 30 is a oscillation source when the signal oscillator 51 generates a reference signal I_{S}. Therefore, the modulation signal added to the reference light L2 using the oscillator 30 and the reference signal I_{S} output from the signal oscillator 51 with the oscillator 30 as the oscillation source both originate from oscillation energy of the oscillator 30. Therefore, even when a disturbance such as an impact or a noise is applied to the optical modulator 12 and the oscillation of the oscillator 30 changes, both the modulation signal and the reference signal I_{S} change in the same way. Accordingly, it is possible to cancel out or reduce the influences of the disturbances on both the modulation signal and the reference signal I_{S} in a process of the arithmetic processing in the demodulation circuit 52. As a result, a decrease in a S/N ratio (a signal-to-noise ratio) of the sample signal demodulated by the demodulation circuit 52 can be suppressed.

The oscillator 30 is, for example, a oscillator using a mechanical resonance phenomenon, such as a quartz crystal oscillator, a ceramic oscillator, or a silicon oscillator. The mechanical resonance of these oscillators has a high Q value and excellent stability of the frequency.

Examples of a quartz crystal oscillator include a quartz crystal AT oscillator, an SC-cut quartz crystal oscillator, a tuning fork type quartz crystal oscillator, and a quartz crystal surface acoustic wave element. An oscillation frequency of the quartz crystal oscillator is about, for example, from 1 kHz to several hundreds of MHz.

The silicon oscillator is a oscillator including a single crystal silicon element manufactured from a single crystal silicon substrate by using a MEMS technology, and a piezoelectric film. The term micro electro mechanical systems (MEMS) refers to a microelectromechanical system. Examples of the shape of the single crystal silicon element include a cantilever beam shape, such as a two-leg tuning fork type and a three-leg tuning fork type, and a double-supported beam shape. An oscillation frequency of the silicon oscillator is about, for example, from 1 kHz to several hundreds of MHz.

The ceramic oscillator is a oscillator including a piezoelectric ceramic element manufactured by baking and hardening a piezoelectric ceramic, and electrodes. Examples of the piezoelectric ceramic include lead zirconate titanate (PZT), barium titanate (BTO), and potassium sodium niobate (KNN). An oscillation frequency of the ceramic oscillator is about, for example, from several hundreds of kHz to several tens of MHz.

Among them, a quartz crystal oscillator is preferably used as the oscillator 30. The quartz crystal oscillator has particularly high frequency stability since the quartz crystal itself is a piezoelectric material.

An oscillation frequency of the oscillator 30 is not particularly limited, and is preferably 1 MHz or more and 100 MHz or less. In a frequency band within the range described above, there are many oscillators with a high Q value of mechanical resonance. Therefore, by setting the oscillation frequency within the range described above, stabilization of a reference frequency of the reference signal I_{S} output from the signal oscillator 51 can be achieved.

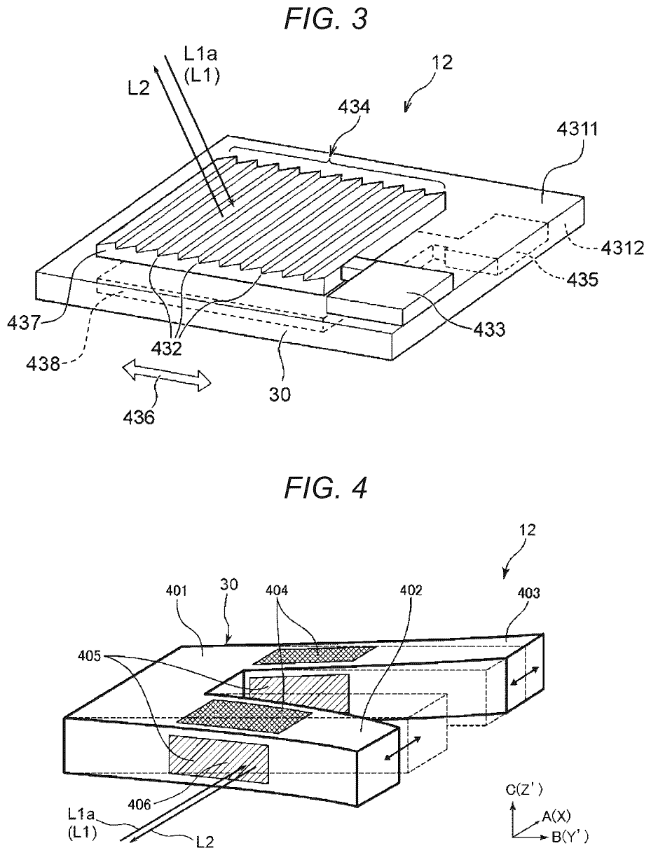

FIG. 3 is a perspective view illustrating a configuration example of the optical modulator 12 illustrated in FIG. 2.

Examples of the optical modulator 12 illustrated in FIG. 3 include an optical modulator disclosed in JP-A-2022-38156. Specifically, the optical modulator 12 illustrated in FIG. 3 includes the oscillator 30 and a diffraction grating 434 that is provided on the oscillator 30 and diffracts the first split light L1a (a split laser light).

The oscillator 30 illustrated in FIG. 3 is a quartz crystal AT oscillator that oscillates in a thickness-shear manner along a oscillation direction 436 in a high-frequency region in the MHz band. The oscillator 30 is provided with the diffraction grating 434. The diffraction grating 434 includes a plurality of linear grooves 432 extending in a direction intersecting with the oscillation direction 436. When such a diffraction grating 434 is irradiated with the first split light L1a, the frequency of the first split light L1a can be modulated to generate the reference light L2 even when the oscillator 30 oscillates in a thickness-shear manner.

The oscillator 30 has a front surface 4311 and a back surface 4312 that are in a front-back relationship with each other. The diffraction grating 434 is disposed on the front surface 4311. A first electrode 437 for applying a voltage to the oscillator 30 and a pad 433 electrically coupled to the first electrode 437 are disposed on the front surface 4311. Meanwhile, a second electrode 438 for applying a voltage to the oscillator 30 and a pad 435 electrically coupled to the second electrode 438 are disposed on the back surface 4312. The first electrode 437 and the second electrode 438 are disposed to overlap each other with the oscillator 30 interposed therebetween when the front surface 4311 is viewed in plan. When a voltage is applied between the first electrode 437 and the second electrode 438, a thickness-shear oscillation is induced in a portion where the first electrode 437 and the second electrode 438 overlap each other.

The diffraction grating 434 illustrated in FIG. 3 is disposed on the first electrode 437. That is, in FIG. 3, the diffraction grating 434 is implemented with the plurality of grooves 432 formed in a surface of the first electrode 437, and when the diffraction grating 434 is irradiated with the first split light L1a, the reference light L2 is emitted as a diffracted light.

The diffraction grating 434 illustrated in FIG. 3 is, for example, a blazed diffraction grating. The blazed diffraction grating refers to a diffraction grating whose cross-sectional shape is a stepped shape. A shape of the diffraction grating 434 is not limited thereto.

FIG. 4 is a perspective view illustrating another configuration example of the optical modulator 12 illustrated in FIG. 2. In FIG. 4, an A axis, a B axis, and a C axis are set as three axes orthogonal to each other, and are represented by arrows. A tip side of the arrow is defined as “plus”, and a base side of the arrow is defined as “minus”.

The oscillator 30 illustrated in FIG. 4 is a tuning fork type quartz crystal oscillator. The oscillator 30 illustrated in FIG. 4 includes a oscillation substrate including a base 401, a first oscillation arm 402 and a second oscillation arm 403. Such a tuning fork type quartz crystal oscillator is easily available since the manufacturing technique thereof has been established, and is stable in oscillation. Therefore, the tuning fork type quartz crystal oscillator is suitable as the oscillator 30. The optical modulator 12 illustrated in FIG. 4 includes the oscillator 30, and electrodes 404 and 405 and light reflection units 406 provided on the oscillator 30.

The base 401 is a region extending along the A axis. The first oscillation arm 402 is a region of the base 401 that extends from an end portion on the negative side of the A axis toward the positive side of the B axis. The second oscillation arm 403 is a region of the base 401 that extends from an end portion on the positive side of the A axis toward the positive side of the B axis.

The electrodes 404 are conductive films disposed on side surfaces parallel to the A-B plane of the first oscillation arm 402 and the second oscillation arm 403. Although not illustrated in FIG. 4, the electrodes 404 are respectively disposed on side surfaces that face each other, and drive the first oscillation arm 402 and the second oscillation arm 403 by being applied with voltages of different polarities to each other.

The electrodes 405 are conductive films disposed on side surfaces intersecting with the A-B plane of the first oscillation arm 402 and the second oscillation arm 403. Although not illustrated in FIG. 4, the electrodes 405 are disposed on side surfaces that face each other, respectively, and drive the first oscillation arm 402 and the second oscillation arm 403 by being applied with voltages of different polarities to each other.

The light reflection units 406 are set on side surfaces intersecting with, for example, the A-B plane of the first oscillation arm 402 and the second oscillation arm 403, and have a function of reflecting the first split light L1a. With this function, since the light reflection unit 406 has a oscillation component with a large amplitude in an incident direction of the incident first split light L1a thereon, it is possible to efficiently modulate the frequency of the first split light L1a to generate the reference light L2.

As the tuning fork type quartz crystal oscillator, a quartz crystal element cut out from a quartz crystal substrate is used. Examples of the quartz crystal substrate used to manufacture the tuning fork type quartz crystal oscillator include a quartz crystal Z-cut flat plate. An X axis parallel to the A axis, a Y′ axis parallel to the B axis, and a Z′ axis parallel to the C axis are set in FIG. 4. The quartz crystal Z-cut flat plate is, for example, a substrate cut out from a single crystal of quartz crystal such that the X axis is an electrical axis, the Y′ axis is a mechanical axis, and the Z′ axis is an optical axis. Specifically, in an orthogonal coordinate system implemented with the X axis, the Y′ axis, and the Z′ axis, a substrate having a main surface tilted counterclockwise by approximately 1° to 5° from an X-Y′ plane implemented with the X axis and Y′ axis around the X axis is cut out from a single crystal of quartz crystal, and is preferably used as the quartz crystal substrate. By etching such a quartz crystal substrate, a quartz crystal element used in the oscillator 30 illustrated in FIG. 4 is obtained.

### 1.3. Signal Oscillator

The signal oscillator 51 illustrated in FIG. 1 generates the reference signal I_{S} using the oscillator 30 as a oscillation source.

Examples of the signal oscillator 51 include an oscillation circuit using an inverter and a Colpitts oscillation circuit. These oscillation circuits operate using fundamental mode oscillation of the oscillator 30 as a oscillation source. Therefore, by using the oscillator 30 with a high Q value of mechanical resonance, the reference signal I_{S} high in frequency stability can be generated.

The optical modulator 12 and the signal oscillator 51 may be housed in one package. Accordingly, since a physical distance between the optical modulator 12 and the signal oscillator 51 is short, the influence of noise or the like is suppressed.

### 1.4. Demodulation Circuit

First, a configuration of the demodulation circuit 52 will be described.

### 1.4.1. Configuration of Demodulation Circuit

The demodulation circuit 52 illustrated in FIG. 1 includes a current-to-voltage converter 520, a high-pass filter 522 (a DC offset removing unit), a bandpass filter 524 (a third filter), a first phase adjuster 526, a second phase adjuster 528, a first multiplier 530, a second multiplier 532, a low-pass filter 534 (a first filter), a low-pass filter 536 (a second filter), an A/D converter 538, an A/D converter 540, a Lissajous corrector 542, a divider 546, an arctangent calculator 548 (a phase calculator), and a signal output unit 550.

The current-to-voltage converter 520 is also called a transimpedance amplifier (TIA), which converts the photocurrent output from the photodetector 10 into a voltage signal and outputs the voltage signal as the laser light reception signal.

The high-pass filter 522 removes an offset (a DC offset) of a direct-current component of the laser light reception signal. Accordingly, an alternating-current component I_{PD.AC} of the laser light reception signal can be extracted.

The bandpass filter 524 passes only a component of the reference frequency with respect to the reference signal I_{S} output from the signal oscillator 51. Accordingly, the reference signal I_{S} from which unnecessary frequency components (noise components) are removed is obtained. When an amount of unnecessary frequency components is small in the reference signal I_{S} output from the signal oscillator 51, the bandpass filter 524 may be omitted.

The first phase adjuster 526 adjusts a phase of the reference signal I_{S} output from the bandpass filter 524. Specifically, the first phase adjuster 526 adjusts the phase of the reference signal I_{S} to be in phase with a phase of a fundamental frequency component of the modulation signal included in the laser light reception signal. Accordingly, it is possible to suppress an influence of a phase delay in the high-pass filter 522, and it is possible to suppress the deterioration of the demodulation precision and the accuracy of phase information X derived from the object 14, which is finally calculated.

The reference signal I_{S} output from the first phase adjuster 526 is split into two signals at a branch point 527. The first phase adjuster 526 is not limited to being disposed at a position illustrated in FIG. 1, and, for example, may be provided between the branch point 527 and the first multiplier 530. In this case, a phase adjustment amount of the second phase adjuster 528 may be changed in the embodiment according to the change of the arrangement.

The second phase adjuster 528 is disposed between the branch point 527 and the second multiplier 532. That is, the second phase adjuster 528 further adjusts the phase of the reference signal I_{S} whose phase has been adjusted by the first phase adjuster 526. Specifically, the second phase adjuster 528 adjusts the phase of one of the reference signals I_{S} output from the first phase adjuster 526 and branched at the branch point 527 to cancel out a phase delay amount in the high-pass filter 522. Accordingly, even when the phase delay amount in the high-pass filter 522 is different due to a difference in frequency of the alternating-current component passing through the high-pass filter 522, it is possible to cancel out or reduce the influence.

The first multiplier 530 multiplies the laser light reception signal output from the high-pass filter 522 by the reference signal I_{S} output from the first phase adjuster 526. Accordingly, a first multiplied signal I_{X1} is obtained. The first multiplied signal Ix is split into a first calculation path PS1 and a second calculation path PS2 at a branch point 531.

The second multiplier 532 multiplies the first multiplied signal Ix divided into the second calculation path PS2 by the reference signal I_{S} output from the first phase adjuster 526. Accordingly, a second multiplied signal I_{X2} is obtained.

The low-pass filter 534 removes a high-frequency component from the first multiplied signal Ix divided into the first calculation path PS1. Accordingly, the low-pass filter 534 outputs a first low-frequency signal I_{LF1} including a low-frequency component. The low-pass filter 534 may be a bandpass filter.

The low-pass filter 536 removes a high-frequency component from the second multiplied signal I_{X2} output from the second multiplier 532. Accordingly, the low-pass filter 536 outputs a second low-frequency signal I_{LF2} including a low-frequency component. The low-pass filter 536 may be a bandpass filter.

The high-pass filter 522 (the DC offset removing unit), the bandpass filter 524, the first phase adjuster 526, the first multiplier 530, the second multiplier 532, the low-pass filter 534, and the low-pass filter 536 are elements of an analog circuit.

The A/D converter 538 digitally converts the analog first low-frequency signal I_{LF1} output from the low-pass filter 534. Accordingly, the digital first low-frequency signal I_{LF1} is obtained.

The A/D converter 540 digitally converts the analog second low-frequency signal I_{LF2} output from the low-pass filter 536. Accordingly, the digital second low-frequency signal I_{LF2} is obtained.

The Lissajous corrector 542 adjusts the amplitudes of the two input signals using a Lissajous figure such that the amplitudes of the two input signals are equal to each other. Specifically, first, a Lissajous figure is drawn, and ellipse approximation processing is performed on the obtained Lissajous figure to obtain an approximate ellipse. Next, a correction value for approximating the approximate ellipse to a perfect circle is calculated. Next, the amplitude of the first low-frequency signal I_{LF1} and the amplitude of the second low-frequency signal I_{LF2} are adjusted based on the calculated correction value. Correction (Lissajous correction) by the Lissajous corrector 542 will be described in detail later.

In the Lissajous corrector 542, only one of the amplitudes of the first low-frequency signal I_{LF1} and the amplitude of the second low-frequency signal I_{LF2} may be adjusted, or both may be adjusted.

The divider 546 performs division by dividing a first low-frequency signal C_{P1}·I_{LF1} after the correction output from the Lissajous corrector 542 to the first calculation path PS1 by a second low-frequency signal C_{P2}·I_{LF2} after the correction output from the Lissajous corrector 542 to the second calculation path PS2. Accordingly, a divided signal is obtained.

The arctangent calculator 548 performs arctangent calculation on the divided signal output from the divider 546. Accordingly, the phase information X derived from the object 14 is calculated.

The signal output unit 550 performs phase connection, such as unwrapping processing, on the phase information x derived from the object 14. The displacement and the speed of the object 14 are calculated as necessary.

The Lissajous corrector 542, the divider 546, the arctangent calculator 548, and the signal output unit 550 may be elements of an analog circuit, and are preferably elements of a digital circuit. Such a digital circuit is installed in an electronic device such as a programmable logic device (FPGA), an application specific integrated circuit (ASIC), or a microcomputer.

### 1.4.2. Demodulation Processing

Next, an operation (the demodulation processing) of the demodulation circuit 52 will be described. In the following description, as an example, a case in which a signal whose frequency changes in a sinusoidal manner is used as the modulation signal and the displacement of the object 14 is in simple harmonic motion in an incident direction of the light will be described.

The laser light reception signal output from the current-to-voltage converter 520 is input to the high-pass filter 522. The high-pass filter 522 removes the DC offset from the laser light reception signal. Accordingly, the alternating-current component I_{PD.AC} of the laser light reception signal can be extracted. The alternating-current component I_{PD.AC} is represented by the following formula (1).

$${I}_{PD \cdot AC} = A cos ( {Φ}_{M} - X ) \qquad ( 1 )$$

In Formula (1), A is a product of an amplitude of the reference light L2 and an amplitude of the object light L3. Φ_{M} is a phase derived from the optical modulator 12 (a phase of the reference light L2). X is phase information given by the following formula (1a).

$$X = {Φ}_{S} - {Φ}_{0} \qquad ( 1 a )$$

In Formula (1a), Φ_{S} is a phase derived from the object 14 (a phase of the object light L3), and Φ₀ is an initial phase difference due to an optical path difference in the interference optical system 50.

The optical modulator 12 illustrated in FIG. 2 generates the reference light L2 including a modulation signal of a modulation frequency f_{M}. Therefore, Φ_{M} is given by the following formula (1b).

$${Φ}_{M} = B sin {ω}_{M} t \qquad ( 1 b )$$

In Formula (1b), ω_{M} is an angular frequency (a modulation angular frequency) of the modulation frequency f_{M}, and ω_{M}=2πf_{M}. T is time. B is a modulation index in frequency modulation in the optical modulator 12. When the oscillation of the oscillator 30 is stable, B has a constant value and is represented by the following formula (1b-1).

$$B = \frac{4 π {L}_{0}}{λ} \qquad ( 1 b - 1 )$$

In Formula (1b-1), L₀ is an amplitude of the oscillator 30 in a direction in which the reference light L2 is emitted. λ is a wavelength of the laser light L1.

When using Formula (1b), Formula (1) is represented by the following formula (1c).

$$\begin{matrix}{I}_{PD \cdot AC} = A cos ( B sin {ω}_{M} t - X ) \\ = A [ cos ( B sin {ω}_{M} t ) cos X + sin ( B sin {ω}_{M} t ) sin X ]\end{matrix} \qquad ( 1 c )$$

When the right side of Formula (1c) is expanded using the series representation of the Bessel function, the following formula (1d) is obtained.

$${I}_{PD \cdot AC} = A [ ( {J}_{0 ( B )} + 2 {J}_{2 ( B )} cos 2 {ω}_{M} t + ⋯ ) cos X + ( 2 {J}_{1 ( B )} sin {ω}_{M} t + ⋯ ) sin X ] \qquad ( 1 d )$$

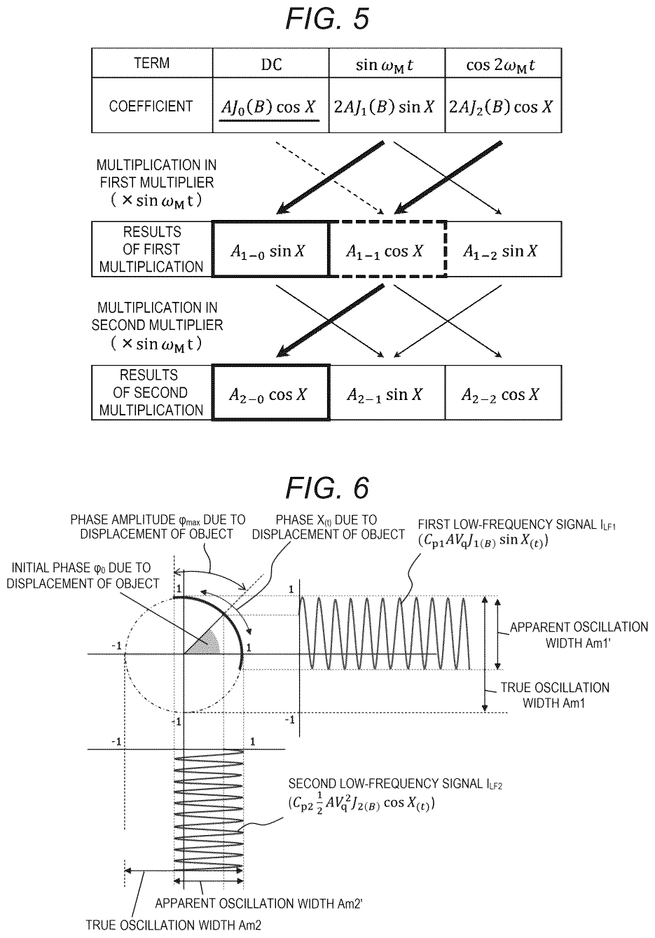

Formula (1d) is divided into a term (a DC term) not including a modulation angular frequency ω_{M}, and terms representing a high-order harmonic wave component, such as a term (a sin ω_{M}t term) including sin ω_{M}t or a term (cos 2ω_{M}t term) including cos 2ω_{M}t. These terms and coefficients included in the terms are illustrated in FIG. 5.

FIG. 5 is a table illustrating coefficients included in the DC term and the term representing the high-order harmonic wave component in the series representation of the laser light reception signal. In FIG. 5, only a part of the terms representing the high-order harmonic wave component is illustrated.

As illustrated in FIG. 5, the coefficients of each term include cos X or sin X. In the demodulation circuit 52, a phase Φ_{S} derived from the object 14 is finally calculated by extracting the coefficients by calculation. Particularly, in the embodiment, sin X included in the coefficient of the sin ω_{M}t term and cos X included in the coefficient of the cos 2ω_{M}t term are extracted, the phase information X is finally obtained, and the phase Φ_{S} is calculated therefrom.

The reference signal I_{S} output from the first phase adjuster 526 is represented by the following formula (2).

$${I}_{S} = {V}_{q} sin {ω}_{M} t \qquad ( 2 )$$

In Formula (2), V_{q} is an amplitude.

The first multiplier 530 multiplies the alternating-current component I_{PD.AC} of the laser light reception signal output from the high-pass filter 522 by the reference signal I_{S} output from the first phase adjuster 526. This multiplication (first multiplication) is an operation of multiplying Formula (1d) by Formula (2). Accordingly, the first multiplied signal I_{X1} is obtained. The first multiplied signal Ix is represented by the following formula (3).

$$\begin{matrix}{I}_{X 1} = {I}_{PD \cdot AC} \cdot {I}_{S} \\ = \begin{matrix}{AV}_{q} [ 2 {J}_{2 ( B )} cos ( 2 {ω}_{M} t ) sin ( {ω}_{M} t ) \\ cos X + 2 {J}_{1 ( B )} sin ( {ω}_{M} t ) sin ( {ω}_{M} t ) sin X ]\end{matrix} \\ = \begin{matrix}{AV}_{q} [ 2 {J}_{2 ( B )} \{ \frac{1}{2} ( sin ( 3 {ω}_{M} t ) - sin ( {ω}_{M} t ) ) \} cos X + \\ 2 {J}_{1 ( B )} \{ - \frac{1}{2} ( cos ( 2 {ω}_{M} t ) - 1 ) \} sin X ]\end{matrix}\end{matrix} \qquad ( 3 )$$

Formula (3) is divided into a term (a DC term) not including the modulation angular frequency WM, and terms representing a high-order harmonic wave component, such as a term (a sin ω_{M}t term) including sin ω_{M}t or a term (cos 2ω_{M}t term) including cos 2ωMt. The respective terms and coefficients included in the respective terms are illustrated in “results of first multiplication” in FIG. 5. In FIG. 5, the coefficients of the respective terms are partially simplified.

The first multiplied signal I_{X1} is divided at the branch point 531 illustrated in FIG. 1. When the first multiplied signal Ix divided into the first calculation path PS1 passes through the low-pass filter 534, a high-frequency component including the modulation angular frequency ω_{M} is cut. A cutoff frequency of the low-pass filter 534 is set to, for example, ω_{M}/2.

The first low-frequency signal I_{LF1} output from the low-pass filter 534 is represented by the following formula (3a).

$${I}_{LF 1} = {AV}_{q} {J}_{1 ( B )} sin X \qquad ( 3 a )$$

Such first multiplication reduces the frequency of the first low-frequency signal I_{LF1} divided into the first calculation path PS1.

FIG. 5 illustrates concepts of the first multiplication. In FIG. 5, transitions of sin X and cos X included in the coefficients due to the first multiplication and second multiplication to be described later are represented by arrows. When the first multiplication is performed, sin X included in the coefficient of the sin ω_{M}t term transitions to the coefficient of the DC term and the coefficient of cos 2ω_{M}t term. Also, cos X included in the coefficient of the cos 2ω_{M}t term transitions to the coefficient of the sin ω_{M}t term.

Then, when the high-frequency component is removed in the low-pass filter 534, only the DC term is output. That is, in the results of the first multiplication illustrated in FIG. 5, the component of the DC term including the coefficient enclosed in the thick solid frame is output from the low-pass filter 534. As described above, the first low-frequency signal I_{LF1} having a low frequency is obtained.

The second multiplier 532 multiplies the first multiplied signal I_{X1} divided into the second calculation path PS2 by the reference signal I_{S} output from the second phase adjuster 528. This multiplication (second multiplication) is an operation of multiplying Formula (3) by Formula (2). Accordingly, the second multiplied signal I_{X2} is obtained. The second multiplied signal I_{X2} is represented by the following formula (4).

$$\begin{matrix}{I}_{X 2} = {I}_{X 1} \cdot {I}_{S} \\ = \begin{matrix}{AV}_{q}^{2} [ {J}_{2 ( B )} \{ ( sin ( 3 {ω}_{M} t ) sin ( {ω}_{M} t ) - sin {( {ω}_{M} t )}^{2} ) \} cos X + \\ 2 {J}_{1 ( B )} \{ - \frac{1}{2} ( cos ( 2 {ω}_{M} t ) sin ( {ω}_{M} t ) - sin ( {ω}_{M} t ) ) \} sin X ]\end{matrix} \\ = \begin{matrix}{AV}_{q}^{2} [ {J}_{2 ( B )} \{ ( sin ( 3 {ω}_{M} t ) sin ( {ω}_{M} t ) - \frac{1 - cos ( 2 {ω}_{M} t )}{2} ) ) \} cos X + \\ 2 {J}_{1 ( B )} \{ - \frac{1}{2} ( cos ( 2 {ω}_{M} t ) sin ( {ω}_{M} t ) - sin ( {ω}_{M} t ) ) \} sin X ]\end{matrix}\end{matrix} \qquad ( 4 )$$

Formula (4) is divided into a term (a DC term) not including the modulation angular frequency ω_{M}, and representing a high-order harmonic wave component, such as a term (a sin ω_{M}t term) including sin ω_{M}t or a term (cos 2ω_{M}t term) including cos 2ω_{M}t. The respective terms and coefficients included in the respective terms are illustrated in “results of second multiplication” in FIG. 5. In FIG. 5, the coefficients of the respective terms are partially simplified.

When the second multiplied signal I_{X2} passes through the low-pass filter 536, the high-frequency component including the modulation angular frequency ωₘ is cut. A cutoff frequency of the low-pass filter 536 is set to, for example, ω_{M}/2. The second low-frequency signal I_{LF2} output from the low-pass filter 536 is represented by the following formula (4a).

$${I}_{LF 2} = \frac{1}{2} {AV}_{q}^{2} {J}_{2 ( B )} cos X \qquad ( 4 a )$$

Although a minus sign is originally attached to the right side of the second low-frequency signal I_{LF2}, in Formula (4a), the right side is multiplied by −1 to give the form of Formula (4a). When the displacement derived from the object 14 is finally obtained, it is not affected by the multiplication.

Such second multiplication reduces the frequency of the second low-frequency signal I_{LF2} divided into the second calculation path PS2.

FIG. 5 illustrates concepts of the second multiplication. When the second multiplication is performed, cos X included in the coefficient of the sin ω_{M}t term (the coefficient enclosed in the thick frame of the broken line) in the results of the first multiplication transitions to the coefficient of the DC term and the coefficient of the cos 2ω_{M}t term. In other terms, sin X similarly transitions from a base end to a tip end of the arrow.

Then, when the high-frequency component is removed in the low-pass filter 536, only the DC term is output. That is, in the results of the second multiplication illustrated in FIG. 5, the component of the DC term including the coefficient enclosed in the thick solid frame is output from the low-pass filter 536. As described above, the second low-frequency signal I_{LF2} having a low frequency is obtained.

In the coefficient enclosed in the thick frame of the broken line among the results of the first multiplication illustrated in FIG. 5, the transition of cos X represented by the broken line arrow and the transition of cos X represented by the thick solid line arrow are superimposed. In this case, cos X after the transition represented by the broken line arrow needs to be removed since it may be a noise component for cos X after the transition represented by the solid line arrow.

Therefore, in the embodiment, the high-pass filter 522 described above is provided with the demodulation circuit 52. As described above, the high-pass filter 522 removes the DC offset from the laser light reception signal. By removing the DC offset, a coefficient (a coefficient of the DC term) underlined in FIG. 5 is removed. Therefore, it is possible to stop the transition of cos X represented by the broken line arrow. As a result, superimposition of noise components can be suppressed.

The first low-frequency signal I_{LF1} including sin X and the second low-frequency signal I_{LF2} including cos X are input to the A/D converter 538 and the A/D converter 540 illustrated in FIG. 1.

The first low-frequency signal I_{LF1} digitally converted by the A/D converter 538 and the second low-frequency signal ILF2 digitally converted by the A/D converter 540 are input to the Lissajous corrector 542.

The Lissajous corrector 542 adjusts the amplitude of the digitally converted first low-frequency signal I_{LF1} and the amplitude of the digitally converted second low-frequency signal I_{LF2} to be equal to each other. Specifically, a gain coefficient C_{P1} and a gain coefficient C_{P2} are determined such that the following formula (5) is satisfied, and these gain coefficients are multiplied. In the present specification, such determination and multiplication of the gain coefficients C_{P1} and C_{P2} is referred to as “Lissajous correction”. The Lissajous correction will be described in detail later.

$${C}_{p 1} {AV}_{q} {J}_{1 ( B )} = {C}_{p 2} \frac{1}{2} {AV}_{q}^{2} {J}_{2 ( B )} \qquad ( 5 )$$

The first low-frequency signal C_{P1}·I_{LF1} after the correction output from the Lissajous corrector 542 to the first calculation path PS1 and the second low-frequency signal C_{P2}·I_{LF2} after the correction output from the Lissajous corrector 542 to the second calculation path PS2 are given by the following formulas (6) and (7), respectively.

$${C}_{p 1} \cdot {I}_{LF 1} = {C}_{p 1} {AV}_{q} {J}_{1 ( B )} sin X \qquad ( 6 )$$

$${C}_{p 2} \cdot {I}_{LF 2} = {C}_{p 2} {AV}_{q}^{2} {J}_{2 ( B )} cos X \qquad ( 7 )$$

The divider 546 performs division by dividing the first low-frequency signal C_{P1}·I_{LF1} after the correction by the second low-frequency signal C_{P2}·I_{LF2} after the correction. Accordingly, a divided signal is obtained.

The arctangent calculator 548 performs arctangent calculation on the divided signal output from the divider 546. An arctangent calculation result Iₐₜₐₙ is represented by the following formula (8).

$${I}_{atan} = atan ( \frac{{C}_{p 1} {AV}_{q} {J}_{1 ( B )} sin X}{{C}_{p 2} \frac{1}{2} {AV}_{q}^{2} {J}_{2 ( B )} cos X} ) = X \qquad ( 8 )$$

Then, the phase information X is obtained from the arctangent calculation result Iₐₜₐₙ represented by Formula (8).

In such demodulation processing, each of frequencies of the first low-frequency signal I_{LF1} and the second low-frequency signal I_{LF2} input to the A/D converters 538 and 540 is controlled to be lower than the modulation frequency f_{M}. That is, the frequencies of the first low-frequency signal I_{LF1} and the second low-frequency signal I_{LF2} input to the digital circuit are reduced (down-converted). Accordingly, corresponding frequencies (sampling frequencies) of the A/D converters 538 and 540 can be reduced. As a result, the cost of the A/D converters 538 and 540 can be reduced.

The digital circuit described above is installed in, for example, an FPGA, and by performing the above-described down-conversion, it is possible to reduce the corresponding frequency of the FPGA or the like. Specifically, for example, even when the oscillator 30 having an oscillation frequency in the MHz band is used, an A/D converter, an FPGA, or the like having a corresponding frequency in the kHz band can be used. Therefore, the above-described down-conversion can also contribute to the cost reduction of an electronic component such as an FPGA.

The restriction on the modulation frequency fy by the optical modulator 12, which has been rate-determining due to the above-described corresponding frequency, can be removed. For example, it is also easy to use the oscillator 30 having a very high modulation frequency f_{M} as the optical modulator 12, which has been difficult to adopt due to the above-described corresponding frequency in the related art. Accordingly, a range of options for the oscillator 30 that can be employed is expanded.

In the analog circuit described above, the number of multipliers is kept low at two. Therefore, mixture of the noise due to the multiplication is suppressed, and it is possible to calculate the phase information X high in precision.

### 1.4.3. Lissajous Correction

Next, the operation of the Lissajous corrector 542 (Lissajous correction) will be described.

In the demodulation processing described above, to precisely obtain the phase information X, it is necessary to increase the precision of the first low-frequency signal C_{P1}·I_{LF1} after the correction and the second low-frequency signal C_{P2}·I_{LF2} after the correction used for the arctangent calculation. For this purpose, in the Lissajous corrector 542, it is necessary to precisely align the amplitude of the digitally converted first low-frequency signal I_{LF1} and the amplitude of the digitally converted second low-frequency signal I_{LF2} with each other, that is, to precisely satisfy Formula (5).

Coefficients A, V_{q}, J_{1(B)}, and J_{2(B)} included in Formula (5) are known. Therefore, if the amplitude of the first low-frequency signal I_{LF1} and the amplitude of the second low-frequency signal I_{LF2} can be detected, the gain coefficients C_{P1} and C_{P2} can be theoretically uniquely determined, and in this case, a ratio of the gain coefficient C_{P1} to the gain coefficient C_{P2} is constant regardless of measurement conditions. However, the ratio of the gain coefficients may change due to the influence of environmental factors, such as disturbance noise. For example, when a distance (a working distance) between the laser interferometer 1 and the object 14 changes, the ratio of the gain coefficients is likely to change.

To solve this problem, for example, an appropriate ratio of gain coefficients may be found before the laser interferometer 1 is used or at a predetermined timing, and the gain coefficients C_{P1} and C_{P2} may be adjusted to appropriate values based on the ratio. According to the Lissajous corrector 542, by finding the optimum ratio of the gain coefficients at the appropriate time, it is possible to determine the appropriate gain coefficients C_{P1} and C_{P2} even when the working distance changes.

In the above-described demodulation processing, the phase information X is included in the coefficient of the DC term. The Lissajous correction is performed based on the amplitude including the influence of disturbance noise or the like. Therefore, the above-described demodulation processing has high robustness against disturbance noise or the like.

On the other hand, the above-described demodulation processing has another problem. In the above-described demodulation processing, the phase information X is included in the coefficient of the DC term. Therefore, when the displacement of the object 14 is small, the calculation precision of the phase information X may decrease. Hereinafter, this problem will be described, and Lissajous correction for solving this problem will be described in detail.

First, phase information due to the displacement of the object 14 is defined as X(t).

FIG. 6 is a conceptual diagram illustrating a problem occurring in the demodulation processing due to a small displacement of the object 14. FIG. 6 illustrates a waveform example of the first low-frequency signal I_{LF1} and a waveform example of the second low-frequency signal I_{LF2} when a change in phase information X₍ₜ₎ is less than one round of the unit circle, and a result of plotting the phase information X₍ₜ₎ on the unit circle. In FIG. 6, the amplitude of the first low-frequency signal I_{LF1} and the amplitude of the second low-frequency signal I_{LF2} are each normalized to 1. In FIG. 6, it is assumed that the displacement of the object 14 is in a simple harmonic motion.

To precisely obtain the phase information X₍ₜ₎, a change in the phase information X₍ₜ₎ due to the displacement of the object 14 is required to be equal to or more than one round of the unit circle (a change equal to or more than one round of the unit circle illustrated in FIG. 6). However, when the displacement of the object 14 is small or when an initial phase φ₀ illustrated in FIG. 6 is not appropriate, the change in the phase information X₍ₜ₎ may not reach one round of the unit circle. Accordingly, maximum values of sin X₍ₜ₎ and cos X₍ₜ₎ may be less than 1, and minimum values thereof may be larger than −1. The maximum values and the minimum values are not maximum values and minimum values to be taken by sin X₍ₜ₎ and cos X₍ₜ₎ assumed in the principle of the demodulation processing. When the gain coefficients C_{P1} and C_{P2} are determined by comparing the maximum values of the respective amplitudes of the first low-frequency signal I_{LF1} and the second low-frequency signal I_{LF2}, the calculation precision of the ratio of the gain coefficients in the arithmetic processing decreases due to such a “deviation”.

As illustrated in FIG. 6, the first low-frequency signal and the second low-frequency signal assumed in the principle of the demodulation processing oscillate with true oscillation widths Am1 and Am2, respectively. However, when the change in the phase information X₍ₜ₎ is less than one round of the unit circle, the first low-frequency signal and the second low-frequency signal oscillate with apparent oscillation widths Am1′ and Am2′ less than the true oscillation widths Am1 and Am2.

Therefore, the apparent oscillation widths Am1′ and Am2′ illustrated in FIG. 6 are regarded as the true oscillation widths Am1 and Am2, the demodulation processing is performed, and the ratio of the gain coefficients deviates from a true value. As a result, the phase information X obtained by the demodulation processing may also deviate from the true value.

However, it is not easy to detect that the change in the phase information X₍ₜ₎ is less than one round of the unit circle. That is, it is not easy to specify the change in the phase information X₍ₜ₎ because it is considered that the displacement of the object 14 is often unknown in view of the use situation of the laser interferometer 1.

Here, a relationship between the phase information X₍ₜ₎ and the displacement of the object 14 will be described. In principle, the following formula (11) is established between the phase information X₍ₜ₎ and a demodulation displacement L₍ₜ₎ of the object 14 demodulated from the phase information X₍ₜ₎.

$${X}_{( t )} = \frac{4 π}{λ} {L}_{( t )} \qquad ( 11 )$$

When the displacement of the object 14 is in a simple harmonic motion, the phase information X₍ₜ₎ is represented by the following formula (12).

$${X}_{( t )} = {ϕ}_{max} sin ( {ω}_{d} t ) + {ϕ}_{0} \qquad ( 12 )$$

In Formula (12), φₘₐₓ is a phase amplitude due to the displacement of the object 14. To simplify the description, the initial phase po is set to 0.

Accordingly, the demodulation displacement L₍ₜ₎ is represented by the following formula (13).

$${L}_{( t )} = {L}_{max} sin ( {ω}_{d} t ) \qquad ( 13 )$$

In Formula (13), Lₘₐₓ is a demodulation displacement amplitude.

Accordingly, the following formula (15) is derived from Formulas (11) to (13).

$${ϕ}_{max} = \frac{4 π}{λ} {L}_{max} \qquad ( 15 )$$

In Formula (15), Lₘₐₓ is the demodulation displacement amplitude.

Here, in order for the maximum values of sin X₍ₜ₎ and Cos X₍ₜ₎ to be 1 and the minimum values thereof to be −1 regardless of the initial phase Φ₀, the following formula (16) needs to be established.

$$π ≦ {ϕ}_{max} \qquad ( 16 )$$

Accordingly, the following formula (17) is derived from Formulas (15) and (16).

$$\frac{λ}{4} ≦ {L}_{max} \qquad ( 17 )$$

From Formula (17), it can be seen that when a displacement amplitude of the object 14 is ¼ or more of the wavelength, the maximum values of sin X₍ₜ₎ and cos X₍ₜ₎ are 1, and the minimum values thereof are −1 regardless of the initial phase φ₀. At this time, the change in the phase information X₍ₜ₎ goes around the unit circle in FIG. 6.

However, if there is such a restriction on the measurable displacement amplitude of the object 14, the usability of the laser interferometer 1 decreases.

Therefore, the Lissajous corrector 542 determines an appropriate gain coefficient using the Lissajous figure such that the calculation precision of the phase information X does not decrease even when the displacement amplitude of the object 14 is small. Accordingly, even when the change in the phase information X₍ₜ₎ is less than one round of the unit circle, it is possible to suppress a decrease in the calculation precision of the phase information X.

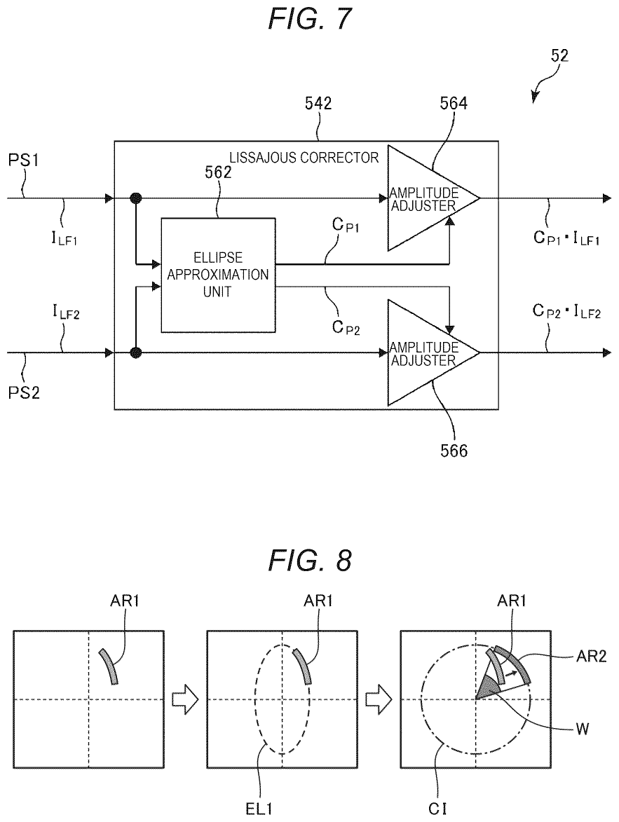

FIG. 7 is a functional block diagram illustrating a configuration of the Lissajous corrector 542 illustrated in FIG. 1. FIG. 8 is a schematic diagram illustrating Lissajous correction by the Lissajous corrector 542 illustrated in FIG. 7.

The Lissajous corrector 542 illustrated in FIG. 7 includes an ellipse approximation unit 562 and amplitude adjusters 564 and 566.

The ellipse approximation unit 562 has a function of drawing a Lissajous figure using the first low-frequency signal I_{LF1} and the second low-frequency signal I_{LF2}. Since the phases of the first low-frequency signal I_{LF1} and the second low-frequency signal I_{LF2} are deviated from each other by about 90°, the drawn Lissajous figure is normally a closed ellipse or an open ellipse. FIG. 8 illustrates, as an example, a Lissajous figure (a Lissajous figure forming an open ellipse) when the change in the phase information X₍ₜ₎ is less than one round of the unit circle. In such a case, as illustrated in FIG. 8, an elliptical arc AR1 having a major axis along a vertical axis and a minor axis along a horizontal axis is drawn as the Lissajous figure.

The ellipse approximation unit 562 has a function of performing the ellipse approximation processing on the Lissajous figure to obtain an approximate ellipse EL1. In the ellipse approximation processing, the approximate ellipse EL1 is fitted to the elliptical arc AR1.

As an example, there is a method of applying the following formula (21) which is an equation of an ellipse.

$${Ax}^{2} + 2 Bxy + {Cy}^{2} + 2 {f}_{0} ( Dx + Ey ) + {f}_{0}^{2} F = 0 \qquad ( 21 )$$

The equation of the ellipse is not limited to Formula (21). In the ellipse approximation processing, the approximate ellipse EL1 that most fits the elliptical arc AR1 is determined by determining A to F and f₀ in Formula (21). Examples of a fitting method include a maximum likelihood estimation, a least squares method, and a weight iteration method.

As a reference document describing the ellipse approximation processing, “Kenta Yokota et al., Comparison of ellipse fitting accuracy: from least squares method to ultra-precision renormalization method, Institute of Electronics, Information and Communication Engineers technical report=IEICE Technical Report, 111(378): 2012.1.19-20, pp. 75-82.” is exemplified. The method described in this reference document may be used.

Next, the ellipse approximation unit 562 calculates a necessary correction value by ellipse approximation processing. Specific examples of the ellipse approximation processing include processing of obtaining the approximate ellipse EL1 that fits the Lissajous figure and calculating a correction value for bringing the approximate ellipse EL1 close to a perfect circle CI. Examples of the correction value include a parameter for deforming the approximate ellipse EL1 into the perfect circle CI. By using such a correction value, appropriate Lissajous correction can be performed. In the example illustrated in FIG. 8, a correction value (a ratio of gain coefficients) for aligning the minor axis of the approximate ellipse EL1 with the major axis is calculated, and the gain coefficients C_{P1} and C_{P2} are determined based on the correction value. The determined gain coefficients C_{P1} and C_{P2} are input to the amplitude adjusters 564 and 566. Accordingly, the elliptical arc AR1 can be corrected to an arc AR2. As a result, a oscillation width W of the phase information X₍ₜ₎ corresponding to the arc AR2 illustrated in FIG. 8 becomes a value closer to the true value than a fluctuation width corresponding to the elliptical arc AR1. Therefore, by using the phase information X₍ₜ₎ corresponding to the arc AR2 obtained by the correction, the displacement of the object 14 can be finally obtained precisely.

The amplitude adjuster 564 has a function of multiplying the first low-frequency signal I_{LF1} by the gain coefficient C_{P1}. Accordingly, it is possible to adjust the amplitude of the first low-frequency signal C_{P1}·I_{LF1} after the correction to be aligned with the amplitude of the second low-frequency signal C_{P2}·I_{LF2} after the correction.

The amplitude adjuster 566 has a function of multiplying the second low-frequency signal I_{LF2} by the gain coefficient C_{P2}. Accordingly, it is possible to adjust the amplitude of the second low-frequency signal C_{P2}·I_{LF2} after the correction to be aligned with the amplitude of the first low-frequency signal C_{P1}·I_{LF1} after the correction.

One of the amplitude adjuster 564 and the amplitude adjuster 566 may be omitted. In this case, the amplitude adjuster 564 is preferably omitted. That is, the gain coefficient C_{P1} may be set to 1, and the ratio of the gain coefficient C_{P2} to the gain coefficient C_{P1} may be calculated to determine the gain coefficient C_{P2}. Accordingly, only the second low-frequency signal I_{LF2} is corrected, and the first low-frequency signal I_{LF1} is used as it is without being corrected (the gain coefficient C_{P1} is set to 1). The reason for doing so is by minimizing the calculation on the first low-frequency signal I_{LF1}, the temporal reliability of the output displacement can be ensured because the real-time property of the first low-frequency signal I_{LF1} is less likely to be impaired.

The processing of bringing the approximate ellipse EL1 close to the perfect circle CI is processing of calculating a correction value for bringing an oblateness of the approximate ellipse EL1 close to 1. At this time, the closer the oblateness is to 1, the higher the effect of correction is. Therefore, an allowable range of the oblateness is found by simulation.

First, an oblateness H in the present specification refers to a value obtained by dividing a diameter derived from the amplitude of the second low-frequency signal I_{LF2} by a diameter derived from the amplitude of the first low-frequency signal I_{LF1} in the approximate ellipse EL1.

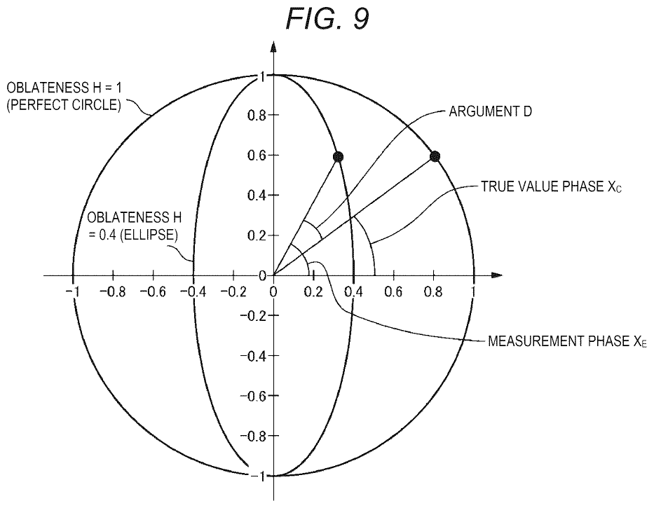

FIG. 9 is a conceptual diagram illustrating influences of a perfect circle having the oblateness H of 1 and an ellipse having the oblateness H of 0.4 on calculation of the phase information X.

When a phase demodulated when the oblateness H is 1 is defined as a true value phase X_{C} and a phase demodulated from the first low-frequency signal I_{LF1} and the second low-frequency signal I_{LF2} having the oblateness H of 0.4 without performing the Lissajous correction is defined as a measurement phase XE, an error of an argument D is present therebetween. The argument D affects the error of the measured displacement.

Therefore, in the above-described simulation, calculation is performed to determine how close the oblateness H is to 1 (how close the argument D is to 0) to keep the measured displacement within an allowable range. As a result, it is found that if the oblateness H can be kept within a range of 0.92 or more and 1.08 or less, the probability that the error of the measured displacement is controlled within 3.0 nm increases regardless of an angle of the true value phase X_{C}. This error is sufficiently excellent as an error when the laser interferometer 1 is used as, for example, a displacement meter. Therefore, in the processing of bringing the approximate ellipse EL1 close to the perfect circle CI, the oblateness H is preferably within a range of 1.00±0.08. In this processing, the oblateness H is more preferably within 1.00±0.05. Accordingly, the probability that the error of the measured displacement is controlled within 2.0 nm increases.

### 1.4.4. Design Example of High-pass Filter

In the high-pass filter 522 illustrated in FIG. 1, the DC offset from the laser light reception signal is removed, and the alternating-current component is transmitted. However, depending on frequency characteristics of the phase delay amount of the alternating-current component transmitted through the high-pass filter 522, a phase delay amount difference between the sin ω_{M}t term and the cos 2ω_{M}t term may become large, the demodulation precision and the accuracy of the phase information X may decrease.

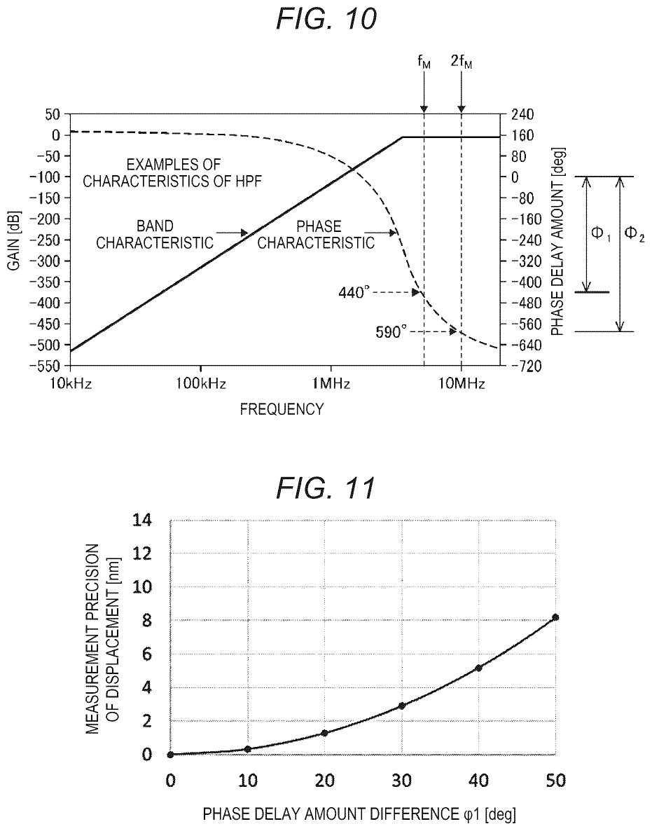

FIG. 10 is a graph illustrating an example of the frequency characteristics of the phase delay amount of the alternating-current component passing through the high-pass filter 522 illustrated in FIG. 1. A horizontal axis represents the frequency. A left vertical axis represents the gain. A right vertical axis represents a phase delay amount when the gain is zero. A passband illustrated in FIG. 10 is a band designed according to the frequency of the alternating-current component intended to pass through the high-pass filter 522. In the example illustrated in FIG. 10, it is assumed that the modulation frequency f_{M} is 5 MHz, and a passband having a lower limit of 5 MHz and an upper limit of 10 MHz corresponding to a frequency 2f_{M} twice the frequency f_{M} is set. By controlling the phase delay amount difference within the passband to be small, it is possible to suppress the decrease in the demodulation precision and the accuracy of the phase information X.

Here, reasons why the phase delay amount difference within the passband affects the demodulation precision of the phase information X are considered.

In FIG. 10, a phase delay amount when a 5 MHz component passes is defined as Φ₁, and a phase delay amount when a 10 MHz component, which is twice the 5 MHz component, passes is defined as Φ₂. In that case, a phase delay amount difference ψ₁ within the passband is given as |Φ₁−Φ₂|. The phase delay amount difference W has an influence represented by the following formula (31) on the arctangent calculation result Iₐₜₐₙ in the demodulation processing.

$${I}_{atan} = atan ( \frac{{C}_{p 1} {AV}_{q} {J}_{1 ( B )} sin X}{{C}_{p 2} \frac{1}{2} {AV}_{q}^{2} {J}_{2 ( B )} cos X cos {ψ}_{1}} ) = X \qquad ( 31 )$$

The middle side of Formula (31) includes cos ψ1 in the denominator and is different from the right side of Formula (8), and therefore, it is found that this difference is an error factor that reduces the demodulation precision of the phase information X.

Therefore, in the embodiment, the high-pass filter 522 is set such that the phase delay amount difference ψ₁ satisfies the following formula (32).

$${ψ}_{1} ≦ 10 [ deg ] \qquad ( 32 )$$

Preferably, the high-pass filter 522 is set such that the following formula (33) is satisfied.

$${ψ}_{1} ≦ 1 [ deg ] \qquad ( 33 )$$

According to such a configuration, the demodulation precision and the accuracy of the phase information X can be improved. As a result, the measurement precision of the displacement of the object 14 and the accuracy of the measured displacement can be improved.

FIG. 11 is a graph illustrating a result of simulating an influence of the phase delay amount difference ψ₁ on the measurement precision of the displacement in the design example illustrated in FIG. 10.

As illustrated in FIG. 11, when the phase delay amount difference ψ₁ is 10 deg or less, the measurement precision of the displacement is controlled to 1 nm or less. Therefore, by setting the phase delay amount difference ψ₁ within the range described above, sufficient measurement precision can be obtained.

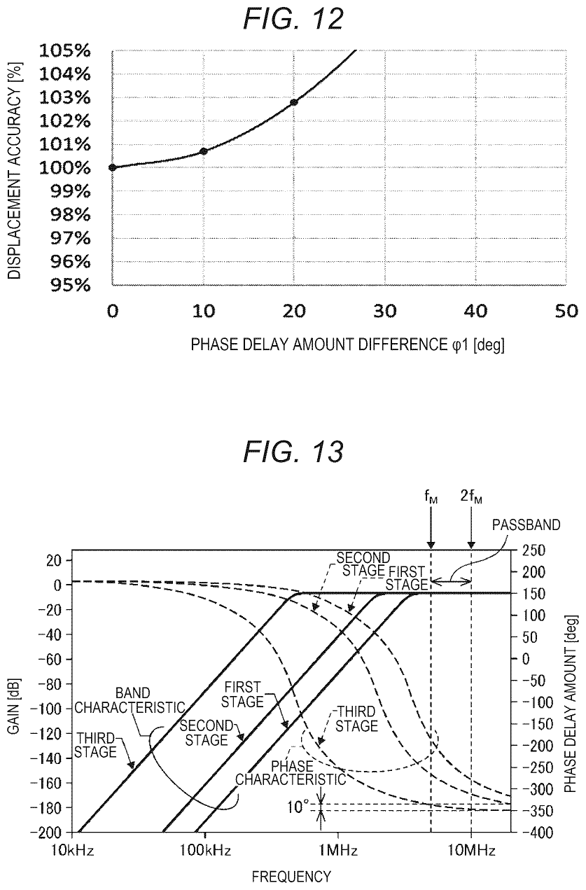

FIG. 12 is a graph illustrating a result of simulating an influence of the phase delay amount difference ψ₁ on the accuracy of the displacement in the design example illustrated in FIG. 10.

As illustrated in FIG. 12, when the phase delay amount difference ψ₁ is 1 deg or less, the accuracy of the measured displacement is approximately 100%, and is strictly controlled within 100±0.01% or less. Therefore, by setting the phase delay amount difference ψ₁ within the range described above, sufficient measurement accuracy can be obtained.

As described above, examples of the method of controlling the phase delay amount difference ψ₁ within a predetermined range include a change in the constants of the elements of the LCR circuit, an increase in the number of stages, and a decrease in the cutoff frequency in the design of the high-pass filter 522.

FIG. 13 is a graph created by calculating frequency characteristics (band characteristics) of a gain and frequency characteristics (phase characteristics) of the phase delay amount when the number of stages is changed to one, two, and three in a high-pass filter implemented with an LCR circuit. When the number of stages is changed, the cutoff frequency of the band characteristic is shifted, and the phase characteristic is also shifted.

In the design example illustrated in FIG. 13, when the number of stages of the LCR circuit is set to three, the phase delay amount difference ψ₁ is controlled to 10 deg or less. In this way, by adjusting the design of the LCR circuit, the phase delay amount difference ψ₁ can be controlled to 10 deg or less or 1 deg or less.

Meanwhile, in the embodiment, by providing the second phase adjuster 528, it is possible to suppress the influence of the phase characteristic in the high-pass filter 522. As a result, the demodulation precision and the accuracy of the phase information X can be further improved while reducing the design load of the high-pass filter 522.

The phase adjustment amount in the second phase adjuster 528 is defined as ψ₂. The phase adjustment amount ψ₂ is ideally made equal to the phase delay amount difference ψ₁ in the high-pass filter 522, but a setting error may occur. Therefore, an influence of a setting error δ(=|ψ₂−ψ₁|) will be considered.

The influence of the setting error δ is the same as the influence of the phase delay amount difference ψ₁. Specifically, by controlling the setting error δ to 10 deg or less, the measurement precision of the displacement can be controlled to 1 nm or less. Accordingly, sufficient measurement precision can be obtained. By controlling the setting error δ to 1 deg or less, the accuracy of the measured displacement can be controlled within 100±0.01%. Accordingly, sufficient measurement accuracy can be obtained.

### 2. Second Embodiment

Then, a laser interferometer according to a second embodiment will be described.

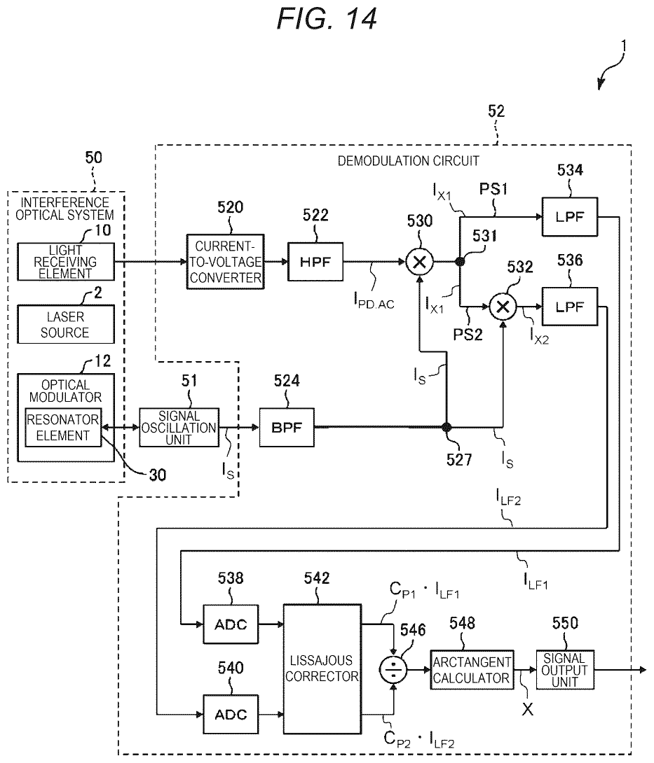

FIG. 14 is a functional block diagram illustrating the laser interferometer 1 according to the second embodiment.

The second embodiment will hereinafter be described, and in the following description, differences from the first embodiment will be focused on, and description of the same matters will be omitted. In FIG. 14, configurations that are the same as those in the first embodiment are denoted by the same reference numerals.

In the first embodiment described above, the first phase adjuster 526 and the second phase adjuster 528 reduce the influence of the phase delay in the high-pass filter 522 (the DC offset removing unit). In contrast, in the second embodiment, the first phase adjuster 526 and the second phase adjuster 528 are omitted from the demodulation circuit 52, and the functions previously performed by these adjusters are assigned to the Lissajous corrector 542.

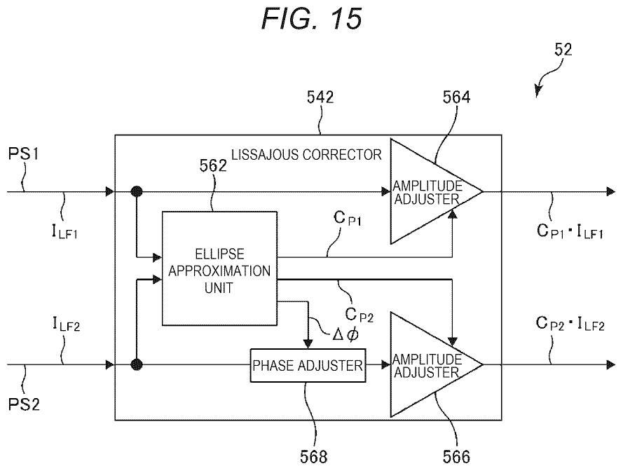

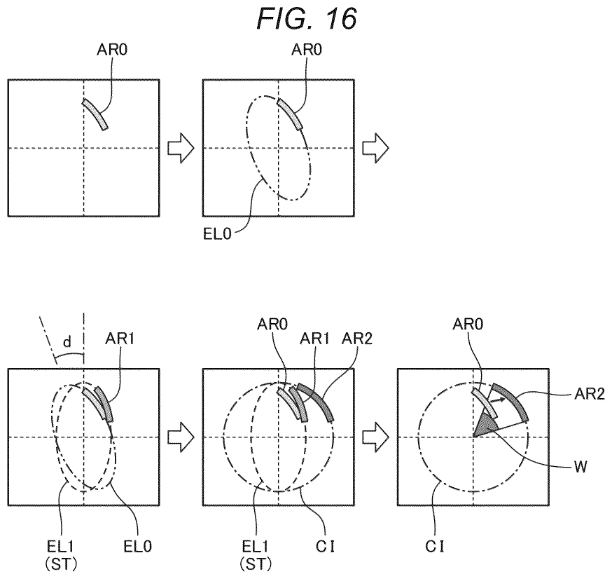

FIG. 15 is a functional block diagram illustrating a configuration of the Lissajous corrector 542 illustrated in FIG. 14. FIG. 16 is a schematic diagram illustrating Lissajous correction by the Lissajous corrector 542 illustrated in FIG. 15.

The Lissajous corrector 542 illustrated in FIG. 15 includes the ellipse approximation unit 562, the amplitude adjusters 564 and 566, and a phase adjuster 568.

The ellipse approximation unit 562 illustrated in FIG. 15 has a function of obtaining an angle difference d of the approximate ellipse EL1 with respect to a reference figure ST.

The ellipse approximation unit 562 illustrated in FIG. 15 determines, based on the angle difference d, a correction phase delay amount Δφ for correcting a phase delay amount of the second low-frequency signal I_{LF2} such that a phase difference of the second low-frequency signal I_{LF2} with respect to the first low-frequency signal I_{LF1} is 90°.

The phase adjuster 568 illustrated in FIG. 15 has a function of adding the correction phase delay amount Δφ to the second low-frequency signal I_{LF2}. Accordingly, the phase difference of the second low-frequency signal I_{LF2} with respect to the first low-frequency signal I_{LF1} can be brought close to 90°. As a result, the phase information X high in precision can be calculated.

In the first embodiment described above, the first phase adjuster 526 and the second phase adjuster 528 are elements of an analog circuit, but in the embodiment, these can be omitted. Accordingly, an advantage of reducing the number of elements of the analog circuit can be obtained.

Next, an operation (Lissajous correction) of the Lissajous corrector 542 illustrated in FIG. 15 will be described.

FIG. 16 illustrates, as an example, a Lissajous figure when a change in the phase information X₍ₜ₎ is less than one round of the unit circle. In this case, as illustrated in FIG. 16, an elliptical arc AR0 is drawn as the Lissajous figure. In the example illustrated in FIG. 16, the elliptical arc AR0 is illustrated when the phase difference between the first low-frequency signal I_{LF1} and the second low-frequency signal I_{LF2} deviates from 90°.

Next, the ellipse approximation unit 562 has a function of performing ellipse approximation processing on the Lissajous figure to obtain an approximate ellipse EL0. In the ellipse approximation processing, the approximate ellipse EL0 is fitted to the elliptical arc AR0.

Next, the ellipse approximation unit 562 obtains the angle difference d of the approximate ellipse EL0 with respect to the reference figure ST. The reference figure ST refers to an ellipse drawn when the phase difference between the first low-frequency signal I_{LF1} and the second low-frequency signal I_{LF2} used for drawing the approximate ellipse EL0 is 90°. Since this ellipse is a figure based on a phase difference desired to be implemented by the correction, the approximate ellipse EL0 may be corrected toward this figure (the reference figure ST).

Therefore, the ellipse approximation unit 562 determines the correction phase delay amount Δφ based on the angle difference d. The determined correction phase delay amount Δφ is input to the phase adjuster 568. Accordingly, the phase adjuster 568 corrects the phase difference of the second low-frequency signal I_{LF2} with respect to the first low-frequency signal I_{LF1} to approach 90°. That is, the Lissajous corrector 542 can perform the role of the first phase adjuster 526 and the second phase adjuster 528 according to the first embodiment. In this case, in the embodiment, the Lissajous corrector 542 has the same function as that of the first embodiment, that is, not only a function of calculating a correction value (a ratio of gain coefficients) and determining the gain coefficients C_{P1} and C_{P2} based on the correction value but also a function of determining the correction phase delay amount Δφ for correcting the phase difference between the first low-frequency signal I_{LF1} and the second low-frequency signal I_{LF2} based on the angle difference d. Accordingly, it is possible to suppress the influence of the phase characteristics in the high-pass filter 522 while reducing the number of elements (the first phase adjuster 526 and the second phase adjuster 528) of the analog circuit, and it is possible to improve the demodulation precision and the accuracy of the phase information X.

The ellipse approximation unit 562 deforms the approximate ellipse EL0 based on the angle difference d to obtain the approximate ellipse EL1.

Next, the ellipse approximation unit 562 calculates a correction value for bringing the approximate ellipse EL1 close to the perfect circle CI, and determines the gain coefficients C_{P1} and C_{P2} based on the correction value. The determined gain coefficients C_{P1} and C_{P2} are input to the amplitude adjusters 564 and 566. As a result, the elliptical arc AR0 illustrated in FIG. 16 can be corrected to the arc AR2. Then, the oscillation width W of the phase information X₍ₜ₎ corresponding to the arc AR2 illustrated in FIG. 16 can be made closer to a true value than a fluctuation width corresponding to the elliptical arc AR0.

In such a second embodiment, the same effects as those of the first embodiment can be obtained.

### 3. Third Embodiment

Next, a laser interferometer according to a third embodiment will be described.

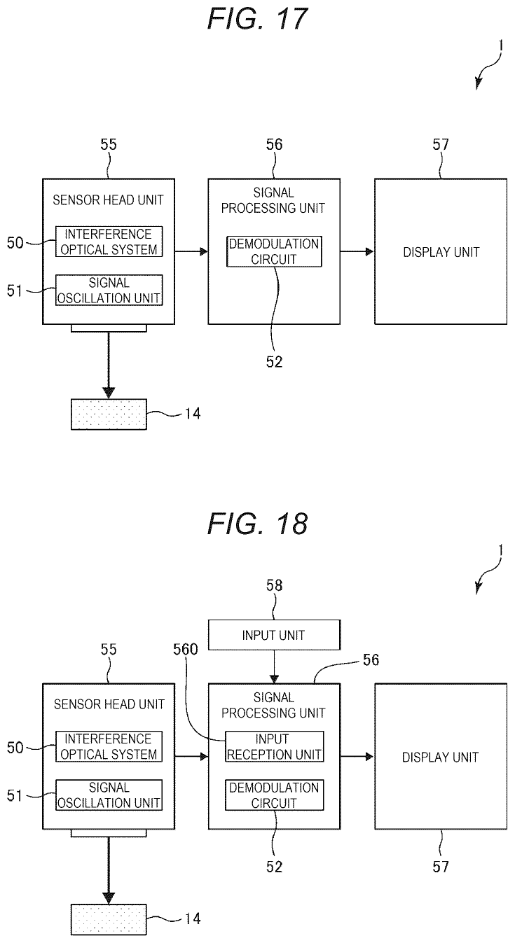

FIG. 17 is a functional block diagram illustrating the laser interferometer 1 according to the third embodiment.

The third embodiment will hereinafter be described, and in the following description, differences from the first embodiment will be focused on, and description of the same matters will be omitted. In FIG. 17, configurations that are the same as those in the first embodiment are denoted by the same reference numerals.

The laser interferometer 1 illustrated in FIG. 17 includes a sensor head unit 55, a signal processing unit 56, and a display unit 57.

The sensor head unit 55 includes the interference optical system 50 and the signal oscillator 51. The sensor head unit 55 is disposed, for example, near the object 14.

The signal processing unit 56 includes the demodulation circuit 52. The signal processing unit 56 may be disposed, for example, at a position away from the sensor head unit 55. The Lissajous corrector 542 provided in the demodulation circuit 52 may have a plurality of operation modes. Examples of the operation mode include an automatic mode in which Lissajous correction is repeatedly executed and a manual mode in which Lissajous correction is executed at any timing. In the automatic mode, Lissajous figures that change over time are drawn one after another based on displacement of the object 14. Then, based on the change in the Lissajous figure, a correction value that changes over time is generated (the correction value is updated). Accordingly, an optimum correction value can be maintained. As a result, in the laser interferometer 1, it is possible to achieve high precision of measurement, improvement of robustness against disturbance, and the like.

The display unit 57 has a function of displaying a measurement result of the object 14. The display unit 57 may further have a function of displaying the operation mode of the Lissajous corrector 542. Accordingly, since a user of the laser interferometer 1 can easily recognize the current operation mode, the usability of the laser interferometer 1 can be improved.

The display unit 57 may display the operation mode by any method. Therefore, examples of the display unit 57 include a display element such as a liquid crystal display element or an organic EL display element that displays the operation mode via an image, a character, or the like, a light-emitting element such as a light-emitting diode that displays the operation mode via a light-emitting pattern, and a sound-emitting element such as a speaker that displays the operation mode via a sound, a tone, or the like.

In addition to the operation mode, the display unit 57 may have a function of displaying a Lissajous figure, a correction value, a demodulated phase, a measured displacement, and the like.

In such a third embodiment, the same effects as those of the first embodiment can be obtained.

### 4. Fourth Embodiment

Next, a laser interferometer according to a fourth embodiment will be described.

FIG. 18 is a functional block diagram illustrating the laser interferometer 1 according to the fourth embodiment.

The fourth embodiment will hereinafter be described, and in the following description, differences from the first embodiment and the third embodiment will be focused on, and description of the same matters will be omitted. In FIG. 18, configurations that are the same as those in the first embodiment and the third embodiment are denoted by the same reference numerals.

The laser interferometer 1 illustrated in FIG. 18 includes the sensor head unit 55, the signal processing unit 56, the display unit 57, and an input unit 58.

The input unit 58 receives an input operation by a user of the laser interferometer 1 and transmits input information to the signal processing unit 56. The signal processing unit 56 switches an operation mode of the Lissajous corrector 542 based on the input information. Examples of the input unit 58 include a keyboard, a touch panel, and a microphone.

The signal processing unit 56 illustrated in FIG. 18 includes an input interface 560. The input interface 560 receives the input information and causes the Lissajous corrector 542 to change the operation mode. Accordingly, the user can execute the correction at any timing. As a result, for example, even when the laser interferometer 1 is used at a site where there is a very large amount of noise, the Lissajous correction can be executed at an appropriate timing, and the correction value can be updated. Accordingly, stable measurement can be performed based on the correction value updated at an appropriate timing. In the manual mode, since the execution frequency of the Lissajous correction is controlled, the processing load of the Lissajous corrector 542 can be reduced.

In such a fourth embodiment, the same effects as those of the first embodiment or the third embodiment can be obtained.

### 5. Fifth Embodiment

Next, a spectrometer according to a fifth embodiment will be described.

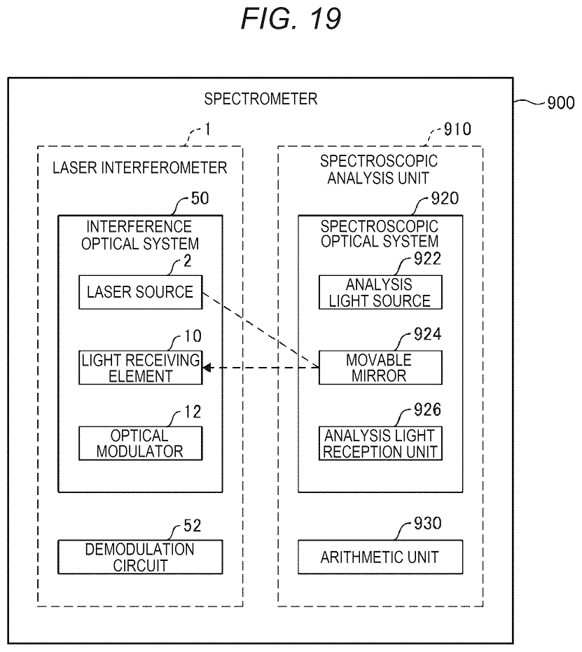

FIG. 19 is a functional block diagram illustrating a spectrometer 900 according to the fifth embodiment.

The fifth embodiment will hereinafter be described, and in the following description, differences from the first embodiment will be focused on, and description of the same matters will be omitted. In FIG. 19, the same configurations as those in FIG. 1 are denoted by the same reference numerals.

The spectrometer 900 illustrated in FIG. 19 includes the laser interferometer 1 (the laser interferometer according to each of the embodiments) and a spectroscopic analyzer 910.

The spectroscopic analyzer 910 receives an analysis light including a sample-derived signal generated through an interaction with the sample to generate spectroscopic spectrum information derived from the sample. The spectroscopic analyzer 910 illustrated in FIG. 19 includes a spectroscopic optical system 920 and an arithmetic unit 930. The spectroscopic optical system 920 includes an analysis light source 922, a movable mirror 924, and an analysis light reception unit 926. In the spectroscopic optical system 920, the analysis light emitted from the analysis light source 922 is emitted onto the sample and then is incident on an analysis light interferometer (not illustrated). The analysis light interferometer causes interference between the analysis light passing through the sample and the analysis light passing through the movable mirror 924 while moving the movable mirror 924 to change an optical path length. Then, the interference light is received by the analysis light reception unit 926 to obtain an analysis light reception signal.

Meanwhile, the laser interferometer 1 measures displacement of the movable mirror 924 to output a mirror position signal. Since the laser interferometer 1 can precisely measure the displacement of the movable mirror 924, the mirror position signal high in precision can be generated.

The arithmetic unit 930 generates a waveform (interferogram) representing an intensity of the interference light with respect to the optical path length in the spectroscopic optical system 920 based on the analysis light reception signal and the mirror position signal, and then performs Fourier transform on the waveform to generate spectroscopic spectrum information.

Therefore, the spectroscopic analyzer 910 can generate the spectroscopic spectrum information high in precision based on the measurement result of the displacement of the movable mirror 924 by the laser interferometer 1. In addition, since the cost of the laser interferometer 1 can be easily reduced, the cost of the spectrometer 900 can be reduced.

By appropriately changing the type of the analysis light, the spectrometer 900 can be applied to Fourier infrared spectroscopy (FT-IR), Fourier near-infrared spectroscopy (FT-NIR), Fourier visible spectroscopy (FT-VIS), Fourier ultraviolet spectroscopy (FT-UV), Fourier terahertz spectroscopy (FT-THz), or the like.

The spectrometer 900 can be applied to, for example, a white-light interferometric shape measurement device or an optical coherence tomography (OCT) imaging device by using an element that can acquire a two-dimensional light intensity distribution as the analysis light reception unit 926.

### 6. Effects Provided by Embodiments Described Above

The laser interferometer 1 according to each of the embodiments emits the second split light L1b (the laser light) onto the object 14, receives the object light L3 (the laser light) passing through the object 14, and acquires displacement of the object 14. The laser interferometer 1 includes the laser source 2, the optical modulator 12, the photodetector 10, the signal oscillator 51, and the demodulation circuit 52. The laser source 2 emits the laser light L1. The optical modulator 12 includes the oscillator 30, and adds a modulation signal to the first split light L1a (the laser light) using the oscillator 30. The photodetector 10 detects a change in intensity of the reference light L2 and the object light L3 (the laser light including the modulation signal and the sample signal added by the object 14), and then outputs laser light reception signal. The signal oscillator 51 generates the reference signal I_{S} of a reference frequency using the oscillator 30 as a oscillation source. The demodulation circuit 52 demodulates the sample signal from the laser light reception signal based on the reference signal I_{S} to acquire the displacement of the object 14.

The demodulation circuit 52 includes the high-pass filter 522 (a DC offset removing unit), the first multiplier 530, the low-pass filter 534 (a first filter), the second multiplier 532, the low-pass filter 536 (a second filter), the Lissajous corrector 542, and the arctangent calculator 548 (a phase calculator).

The high-pass filter 522 removes a direct-current component of the laser light reception signal and extracts the alternating-current component I_{PD.AC}. The first multiplier 530 multiplies the alternating-current component I_{PD.AC} by the reference signal I_{S} and outputs the first multiplied signal I_{X1}. The low-pass filter 534 removes a high-frequency component included in the first multiplied signal I_{X1} and outputs the first low-frequency signal I_{LF1}. “The second multiplier 532 multiplies the first multiplied signal I_{X1} by the reference signal I_{S} and outputs the second multiplied signal I_{X2}. The low-pass filter 536 removes a high-frequency component included in the second multiplied signal I_{X2} and outputs the second low-frequency signal I_{LF2}.

The Lissajous corrector 542 performs ellipse approximation processing on a Lissajous figure drawn using the first low-frequency signal I_{LF1} and the second low-frequency signal I_{LF2}, and adjusts at least one of the amplitudes of the first low-frequency signal I_{LF1} and the amplitude of the second low-frequency signal I_{LF2} based on a correction value obtained by the ellipse approximation processing.

The arctangent calculator 548 demodulates the sample signal based on the first low-frequency signal C_{P1}·I_{LF1} after the correction and the second low-frequency signal C_{P2}·I_{LF2} after the correction output from the Lissajous corrector 542, and calculates the phase information X derived from the object 14.

According to such a configuration, the frequencies of the first low-frequency signal I_{LF1} and the second low-frequency signal I_{LF2} generated in the demodulation circuit 52 are reduced. Accordingly, for example, a corresponding frequency of the FPGA or the like in which a part of the A/D converters 538 and 540 and the demodulation circuit 52 are installed can be lowered, and the cost reduction can be implemented.

According to such a configuration, by performing Lissajous correction in the Lissajous corrector 542, it is possible to implement the laser interferometer 1 that can precisely perform measurement even when the displacement of the object 14 is small.

In the laser interferometer 1 according to each of the embodiments, it is preferable that the Lissajous corrector 542 obtains the approximate ellipse EL1 that fits the Lissajous figure in the ellipse approximation processing, and calculates the correction value for bringing the approximate ellipse EL1 close to the perfect circle CI.

According to such a configuration, appropriate Lissajous correction can be performed.

In the laser interferometer 1 according to each of the embodiments, the Lissajous corrector 542 may set a Lissajous figure when a phase difference between the first low-frequency signal I_{LF1} and the second low-frequency signal I_{LF2} is 90° as the reference figure ST, obtain the angle difference d of the approximate ellipse EL0 with respect to the reference figure ST, and correct the phase difference between the first low-frequency signal I_{LF1} and the second low-frequency signal I_{LF2} based on the angle difference d.

According to such a configuration, the phase difference between the first low-frequency signal I_{LF1} and the second low-frequency signal I_{LF2} can be brought close to 90°. Accordingly, since the influence of the phase characteristic in the high-pass filter 522 can be suppressed, the demodulation precision and the accuracy of the phase information X can be improved.

In the laser interferometer 1 according to each of the embodiments, the demodulation circuit 52 may include the bandpass filter 524 (a third filter). In this case, the bandpass filter 524 is provided between the signal oscillator 51 and the first multiplier 530, and extracts a component of the reference frequency included in the reference signal I_{S}.

According to such a configuration, the reference signal I_{S} from which unnecessary frequency components (noise components) are removed is obtained.

In the laser interferometer 1 according to each of the embodiments, the demodulation circuit 52 may include the first phase adjuster 526. In this case, the first phase adjuster 526 is provided between the bandpass filter 524 (the third filter) and the first multiplier 530 and adjusts the phase of the reference signal I_{S}.

According to such a configuration, the influence of the phase delay in the high-pass filter 522 can be suppressed, and a deterioration of the demodulation precision and the accuracy of the finally calculated phase information X can be suppressed.

In the laser interferometer 1 according to each of the embodiments, it is preferable that the first phase adjuster 526 adjusts the phase of the reference signal I_{S} to be in phase with the fundamental frequency component of the modulation signal.

According to such a configuration, the phase of the fundamental frequency component of the modulation signal included in the laser light reception signal and the phase of the reference signal I_{S} can be made uniform. Accordingly, it is possible to suppress a degradation of the demodulation precision and the accuracy of the phase information X.

In the laser interferometer 1 according to each of the embodiments, the demodulation circuit 52 may include the second phase adjuster 528. In this case, the second phase adjuster 528 is provided between the first phase adjuster 526 and the second multiplier 532, and adjusts the phase of the reference signal I_{S} from a phase that is in phase with a fundamental frequency component of the modulation signal included in the laser light reception signal such that a component of the reference frequency has the phase adjustment amount ψ₂ equal to the phase delay amount difference ψ₁ in a passband of the high-pass filter 522 (the DC offset removing unit).

According to such a configuration, it is possible to offset or reduce the influence of the phase characteristic in the high-pass filter 522. The design load of the high-pass filter 522 can be reduced.

In the laser interferometer 1 according to each of the embodiments, it is preferable that the high-pass filter 522 (the DC offset removing unit) is set such that ψ₁<10 deg, where ψ₁ is a difference between a phase delay amount Φ₁ when a fundamental frequency component of the modulation signal passes and a phase delay amount Φ₂ when a frequency component that is twice the fundamental frequency component of the modulation signal passes.

According to such a configuration, the demodulation precision and the accuracy of the phase information X can be improved. Accordingly, the measurement precision of the displacement of the object 14 and the accuracy of the measured displacement can be improved.

In the laser interferometer 1 according to each of the embodiments, it is preferable that the high-pass filter 522 (the DC offset removing unit) is set such that the phase delay amount difference ψ₁ satisfies ψ₁≤1 deg.

According to such a configuration, the demodulation precision and the accuracy of the phase information X can be improved. Accordingly, the measurement precision of the displacement of the object 14 and the accuracy of the measured displacement can be improved.

In the laser interferometer 1 according to each of the embodiments, the Lissajous corrector 542 may update the correction value based on the Lissajous figure that changes over time.

According to such a configuration, an optimum correction value can be maintained. As a result, in the laser interferometer 1, it is possible to achieve high precision of measurement, improvement of robustness against disturbance, and the like.

The laser interferometer 1 according to each of the embodiments may include the input interface 560 that receives input information by a user. In this case, the Lissajous corrector 542 updates the correction value based on the input information received by the input interface 560.

According to such a configuration, it is possible to implement the laser interferometer 1 that enables stable measurement based on the correction value updated ata appropriate timing.

In the laser interferometer 1 according to each of the embodiments, it is preferable that a wavelength of the laser light L1 emitted by the laser source 2 is constant.

According to such a configuration, simplification of the configuration, reduction in size, and load reduction of the laser source 2 can be obtained.

The spectrometer 900 according to the embodiment includes the laser interferometer 1 according to each of the embodiments and the spectroscopic analyzer 910. The spectroscopic analyzer 910 includes the spectroscopic optical system 920 including the movable mirror 924, and generates the spectroscopic spectrum information derived from the sample. The laser interferometer 1 measures displacement of the movable mirror 924. Then, the spectroscopic analyzer 910 generates the spectroscopic spectrum information based on a measurement result of the displacement of the movable mirror 924 measured by the laser interferometer 1.

According to such a configuration, the spectrometer 900 that can generate the spectroscopic spectrum information high in precision is obtained. The spectrometer 900 can be obtained at a lower cost.

Although the laser interferometer and the spectrometer according to the present disclosure are described hereinabove based on the illustrated embodiments, the laser interferometer and the spectrometer according to the present disclosure are not limited to each of the embodiments. The configuration of each unit may be substituted with any other constituents, or any other constituents may be added thereto.

Although a Michelson type interference optical system is used in each of the embodiments, other types of interference optical systems may be used.

What is claimed is:

1. A laser interferometer comprising:
a laser source configured to emit the laser light;
an optical modulator including an oscillator and configured to add a modulation signal to the laser light using the oscillator;
a photodetector configured to detect a change in intensity of the laser light including the modulation signal and a sample signal added by an object and configured to output laser light reception signal;
a signal oscillator configured to generate a reference signal of a reference frequency using the oscillator as an oscillation source; and
a demodulation circuit configured to demodulate the sample signal from the laser light reception signal based on the reference signal and configured to acquire displacement of the object, wherein
the demodulation circuit includes
a DC offset removing unit configured to remove a direct-current component from the laser light reception signal and extract an alternating-current component,
a first multiplier configured to multiply the alternating-current component by the reference signal and output a first multiplied signal,
a first filter configured to remove a high-frequency component included in the first multiplied signal and output a first low-frequency signal,
a second multiplier configured to multiply the first multiplied signal by the reference signal and output a second multiplied signal,
a second filter configured to remove a high-frequency component included in the second multiplied signal and output a second low-frequency signal,
a Lissajous corrector configured to perform ellipse approximation processing on a Lissajous figure drawn using the first low-frequency signal and the second low-frequency signal, and adjust, based on a correction value obtained by the ellipse approximation processing, at least one of an amplitude of the first low-frequency signal and an amplitude of the second low-frequency signal, and
a phase calculator configured to demodulate the sample signal based on the first low-frequency signal after correction and the second low-frequency signal after correction which are output from the Lissajous corrector and calculate phase information derived from the object.

2. The laser interferometer according to claim 1, wherein
in the ellipse approximation processing, the Lissajous corrector obtains an approximate ellipse that fits the Lissajous figure and calculates the correction value for bringing the approximate ellipse close to a circle.

3. The laser interferometer according to claim 2, wherein
the Lissajous corrector sets the Lissajous figure when a phase difference between the first low-frequency signal and the second low-frequency signal is 90° as a reference figure, obtains an angle difference of the approximate ellipse with respect to the reference figure, and corrects the phase difference between the first low-frequency signal and the second low-frequency signal based on the angle difference.

4. The laser interferometer according to claim 1, wherein
the demodulation circuit includes a third filter disposed between the signal oscillator and the first multiplier and configured to extract a component of the reference frequency included in the reference signal.

5. The laser interferometer according to claim 4, wherein
the demodulation circuit includes a first phase adjuster provided between the third filter and the first multiplier and configured to adjust a phase of the reference signal.

6. The laser interferometer according to claim 5, wherein
the first phase adjuster adjusts the phase of the reference signal to be in phase with a fundamental frequency of the modulation signal.

7. The laser interferometer according to claim 5, wherein
the demodulation circuit includes a second phase adjuster provided between the first phase adjuster and the second multiplier and configured to adjust the phase of the reference signal from a phase that is in phase with a fundamental frequency of the modulation signal included in the laser light reception signal such that a component of the reference frequency has a phase adjustment amount equal to a phase delay amount difference in a passband of the DC offset removing unit.

8. The laser interferometer according to claim 1, wherein
the DC offset removing unit is set such that ψ₁≤10 deg, where ψ₁ is a difference between a phase delay amount when a fundamental frequency of the modulation signal passes and a phase delay amount when a frequency that is twice the fundamental frequency of the modulation signal passes.

9. The laser interferometer according to claim 8, wherein
the DC offset removing unit is set such that a phase delay amount difference ψ₁ satisfies ψ₁≤1 deg.

10. The laser interferometer according to claim 1, wherein
the Lissajous corrector updates the correction value based on the Lissajous figure that changes over time.

11. The laser interferometer according to claim 1, further comprising:
an input interface configured to receive input information by a user, wherein
the Lissajous corrector updates the correction value based on the input information received by the input interface.

12. The laser interferometer according to claim 1, wherein
a wavelength of the laser light emitted by the laser source is constant.

13. A spectrometer comprising:
the laser interferometer according to claim 1; and
a spectroscopic analyzer that includes a spectroscopic optical system including a movable mirror and that is configured to generate spectroscopic spectrum information derived from a sample, wherein
the laser interferometer measures displacement of the movable mirror, and
the spectroscopic analyzer generates the spectroscopic spectrum information based on a measurement result of the displacement of the movable mirror measured by the laser interferometer.
